(19) United States
(12) Patent Application Publication
(10) Pub. No.: US 2009/0283464 A1
(43) Pub. Date: Nov. 19, 2009

(54) WATER FEED DEVICE

(76) Inventors: Hana Oe, Gunma (JP); Hiroyuki Umezawa, Gunma (JP); Yasuteru Sumida, Gunma (JP); Yui Ogawa, Gunma (JP); Tomohito Koizumi, Gunma (JP); Toru Kawabata, Gunma (JP)

Correspondence Address: MCDERMOTT WILL & EMERY LLP, 600 13TH STREET, N.W., WASHINGTON, DC, 20005-3096, US

(21) Appl. No.: 12/306,625

(22) PCT Filed: Jun. 27, 2007
(86) PCT No.: PCT/JP2007/062936

§ 371 Date: Dec. 24, 2008

(30) Foreign Application Priority Data
Jun. 28, 2006 (JP) 2006-177934
Sep. 8, 2006 (JP) 2006-243867
Jun. 22, 2007 (JP) 2007-164879

(51) Int. Cl. F25B 37/00; C02F 1/68

(52) U.S. Cl. 210/198.1; 62/271

(57) ABSTRACT

There is disclosed a water feed device capable of adding mineral components to for-treatment water in accordance with user's request to feed a variety of water including the mineral components from soft water to hard water. Furthermore, there is disclosed a water feed device capable of selecting a treatment function to be performed with respect to the for-treatment water in accordance with the type of water for use as the for-treatment water, a use situation and a purpose, to perform an optimum treatment. A water feed device S of the present invention includes a mineral addition treatment unit which has one or more mineral components and which adds the mineral components to the for-treatment water; and a control unit which has data concerning the one or more mineral components of mineral water and which controls the addition of the mineral components by the mineral addition treatment unit in accordance with the selected mineral water.

### BACKGROUND OF THE INVENTION

The present invention relates to a water feed device which adds mineral components to water to be treated, to feed water.

Heretofore, there have been developed a device which removes, from tap water, inorganic substances including cations (especially, metal ions) which impair the flavor of a beverage and a device which adds mineral components such as calcium, potassium and magnesium to make good water (e.g., see Japanese Patent Application Laid-Open No. 2006-95510).

Additionally, in recent years, consciousness and interest in water have further grown, and not only good and safe water but also a variety of water containing mineral components tend to be picked. However, heretofore, a device capable of making and feeding a plurality of types of water containing the mineral components has not been present.

Furthermore, in the conventional water feed device, as to water for use as water to be treated (hereinafter referred to as “the for-treatment water”), the tap water is generally a target. This tap water is already subjected to a sterilization treatment, and an organic substance treatment does not have to be performed. After once removing, from the tap water, all inorganic substances including cations (especially, metal ions) which impair flavor, only mineral components such as magnesium, calcium, potassium, sodium and silica are added as water tasty components by mineral addition treatment means, whereby the tap water can be treated into safe and good water.

However, when water other than the tap water is used as the for-treatment water, for example, when natural water such as spring water or well water is used as the for-treatment water, the tasty components inherent in the spring water or the well water itself are included, and it is therefore preferable to remove organic substances such as gems included in the water without removing any tasty component. Furthermore, even in a case where a water content collected from air is used as the for-treatment water in a district or a situation in which it is difficult to secure the water as in a desert district or a disaster district, it has been demanded that potable water be fed. Additionally, in the disaster district or the like, a device capable of feeding the potable water with a minimum treatment regardless of the taste of the water has been demanded.

### SUMMARY OF THE INVENTION

The present invention has been developed to solve such a conventional technical problem, and an object thereof is to provide a water feed device capable of adding mineral components to for-treatment water in accordance with user's request to feed a variety of water containing the mineral components.

Furthermore, another object is to provide a water feed device capable of selecting a treatment function to be performed with respect to for-treatment water in accordance with the type, use situation and purpose of water for use as the for-treatment water, to perform an optimum treatment.

That is, a water feed device of the present invention is a water feed device which adds mineral components to for-treatment water to feed water, characterized by comprising: addition treatment means which has one or more mineral components and which adds the mineral components to the for-treatment water; and control means which has data concerning the one or more mineral components of mineral water and which controls the addition of the mineral components by the mineral addition treatment means in accordance with the selected mineral water.

The water feed device according to the invention of a second aspect is characterized in that in the above invention, the control means allows the mineral addition treatment means to add the mineral components in such a predetermined order and/or from such a portion as to avoid the generation of precipitation accompanying the addition of the mineral components.

The water feed device according to the invention of a third aspect is characterized in that in the above inventions, the control means controls the addition of the mineral components by the mineral addition treatment means based on the conductivity of the for-treatment water.

The water feed device according to the invention of a fourth aspect is characterized in that the invention according to any one of the first to third aspects further comprises, in the previous stage of the mineral addition treatment means, inorganic substance removal treatment means for removing inorganic substances contained in the for-treatment water and organic substance removal treatment means for removing organic substances contained in the for-treatment water.

The water feed device according to the invention of a fifth aspect is characterized in that in the invention of the fourth aspect, the control means includes selection means for selecting whether the mineral addition treatment means, the inorganic substance removal treatment means or the organic substance removal treatment means performs a treatment function with respect to the for-treatment water.

The water feed device according to the invention of a sixth aspect is characterized in that in the invention of the fifth aspect, it is constituted that the for-treatment water successively flows through the inorganic substance removal treatment means, the organic substance removal treatment means and the mineral addition treatment means, and the selection means includes a bypass circuit which bypasses the treatment means, respectively, to supply the for-treatment water, and flow path control means for controlling whether to supply the for-treatment water to the treatment means or the bypass circuit.

The water feed device according to the invention of a seventh aspect is characterized in that in the invention according to any one of the fourth to sixth aspects, the inorganic substance removal treatment means is constituted of means for removing cations and/or scale components contained in the for-treatment water, and the organic substance removal treatment means is constituted of means for sterilizing the for-treatment water or removing germs from the for-treatment water.

The water feed device according to the invention of an eighth aspect is characterized in that in the invention of the seventh aspect, the inorganic substance removal treatment means is constituted of one or all of means for electrolyzing the inorganic substances by use of a carbon fiber, means for removing the inorganic substances by use of an adsorbent and means for removing the inorganic substances by use of a reverse osmosis membrane, and the organic substance removal treatment means is constituted of one or both of means for adsorptive removal the organic substances by use of a carbon fiber and means for removing the organic substances by use of a filter film.

The water feed device according to the invention of a ninth aspect is characterized in that the invention of the eighth aspect has a treatment mode to selectively operate the organic substance removal treatment means including one of the means for adsorptive removal the organic substances by use of the carbon fiber and the means for removing the organic substances by use of the filter film in a state in which the inorganic substance removal treatment means and the mineral addition treatment means are not operated with respect to the for-treatment water.

The water feed device according to the invention of a tenth aspect is characterized in that the invention according to any one of the fourth to ninth aspects has a treatment mode to operate the inorganic substance removal treatment means and the mineral addition treatment means in a state in which the organic substance removal treatment means is not operated with respect to the for-treatment water.

The water feed device according to the invention of an eleventh aspect is characterized in that the invention according to any one of the fourth to tenth aspects further comprises: storage means for receiving the for-treatment water obtained in a case where one or all of the treatment means performs a treatment function or all the treatment means do not perform the treatment function; and a circulation circuit which circulates the for-treatment water received in this storage means between the storage means and the organic substance removal treatment means.

The water feed device according to the invention of a twelfth aspect is characterized in that in the invention of the eleventh aspect, the storage means is interposed between the inorganic substance removal treatment means as well as the organic substance removal treatment means and the mineral addition treatment means.

The water feed device according to the invention of a thirteenth aspect is characterized in that the invention of the eleventh or twelfth aspect has a treatment mode to supply the for-treatment water to the circulation circuit and to selectively operate the organic substance removal treatment means including one of the means for adsorptive removal the organic substances by use of the carbon fiber and the means for removing the organic substances by use of the filter film.

The water feed device according to the invention of a fourteenth aspect is characterized in that the invention according to any one of the first to thirteenth aspects further comprises: water content collection means for collecting a water content included in air, water collected by this water content collection means being the for-treatment water.

The water feed device according to the invention of a fifteenth aspect is characterized in that in the invention of the fourteenth aspect, the water content collection means is constituted of an evaporator having a refrigeration cycle constituted of a compressor, a radiator, a pressure reduction unit and the evaporator or an adsorbent configured to adsorb and discharge the water content.

The water feed device according to the invention of a sixteenth aspect is characterized in that the invention according to any one of the first to fourteenth aspects further comprises: ice generation means for freezing water, water obtained by melting the ice generated by this ice generation means being the for-treatment water.

According to the present invention, the water feed device which adds the mineral components to for-treatment water to feed the water comprises the addition treatment means which has one or more mineral components and which adds the mineral components to the for-treatment water; and the control means which has the data concerning the one or more mineral components of the mineral water and which controls the addition of the mineral components by the mineral addition treatment means in accordance with the selected mineral water. Therefore, the amount of the mineral components to be added to the for-treatment water can be selected to make and feed the water including the mineral components in accordance with user's request.

In particularly, as in the invention of the second aspect, the control means allows the mineral addition treatment means to add the mineral components in such a predetermined order and/or from such a portion as to avoid the generation of the precipitation accompanying the addition of the mineral components. In consequence, a disadvantage generated by the precipitation due to the addition of the mineral components.

Moreover, in the invention of the third aspect, the control means controls the addition of the mineral components by the mineral addition treatment means based on the conductivity of the for-treatment water. Therefore, in a case where the mineral components are added so that the conductivity of the for-treatment water is a predetermined conductivity set in advance, the amount of the mineral components to be added can easily be managed, and the desired amount of the mineral components can securely be added to the for-treatment water.

Furthermore, in the invention of the fourth aspect, the above invention further comprises, in the previous stage of the mineral addition treatment means, the inorganic substance removal treatment means for removing the inorganic substances contained in the for-treatment water and the organic substance removal treatment means for removing the organic substances contained in the for-treatment water. Therefore, the inorganic substance removal treatment means can remove inorganic substances such as dust, cations and/or scale components contained in the for-treatment water, and the organic substance removal treatment means can remove organic substances such as the germs contained in the for-treatment water.

In particular, as in the fifth aspect, the invention of the fourth aspect includes the selection means for selecting whether the mineral addition treatment means, the inorganic substance removal treatment means or the organic substance removal treatment means performs the treatment function with respect to the for-treatment water. In this case, the selection means can select the treatment function to be performed with respect to the for-treatment water.

Moreover, as in the invention of the sixth aspect, it is constituted that the for-treatment water successively flows through the inorganic substance removal treatment means, the organic substance removal treatment means and the mineral addition treatment means. In consequence, the organic substance removal treatment means can treat the for-treatment water from which the inorganic substances have been removed by the inorganic substance removal treatment means. Therefore, the organic substance removal treatment means can smoothly perform the removal treatment of the organic substances. Furthermore, the inorganic substance removal treatment means removes the inorganic substances, the organic substance removal treatment means removes the organic substances, and then the mineral addition treatment means can add the mineral components. Therefore, cations such as metal ions and the germs which are harmful to human bodies are removed, and then the only necessary mineral components can be added. In consequence, suitably potable, good and safe water can be manufactured.

In addition, the selection means includes the bypass circuit which bypasses the treatment means, respectively, to supply the for-treatment water, and the flow path control means for controlling whether to supply the for-treatment water to the treatment means or the bypass circuit. In this case, the flow path control means controls whether to feed the for-treatment water to the treatment means or the bypass circuit, whereby the treatment function can easily be selected.

According to the invention of the seventh aspect, in the invention according to any one of the fourth to sixth aspects, the inorganic substance removal treatment means is constituted of the means for removing the cations and/or the scale components contained in the for-treatment water, and the organic substance removal treatment means is constituted of the means for sterilizing the for-treatment water or removing the germs from the for-treatment water. Therefore, for example, as in the eighth aspect, the inorganic substance removal treatment means is constituted of one or all of the means for electrolyzing the inorganic substances by use of the carbon fiber, the means for removing the inorganic substances by use of the adsorbent and the means for removing the inorganic substances by use of the reverse osmosis membrane. Moreover, the organic substance removal treatment means is constituted of one or both of the means for adsorptive removal the organic substances by use of the carbon fiber and the means for removing the organic substances by use of the filter film. In this case, the inorganic substance removal treatment means removes inorganic substances such as the cations and/or the sale components contained in the for-treatment water, and the organic substance removal treatment means can sterilize the for-treatment water or remove the germs. In consequence, potable water can be made.

In particular, according to the invention of the ninth aspect, the water feed device has the treatment mode to selectively operate the organic substance removal treatment means including one of the means for adsorptive removal the organic substances by use of the carbon fiber and the means for removing the organic substances by use of the filter film in a state in which the inorganic substance removal treatment means and the mineral addition treatment means are not operated with respect to the for-treatment water. Therefore, an only organic substance removal treatment function can be operated with respect to the for-treatment water. In consequence, the only organic substance removal treatment means can be operated with respect to the for-treatment water at an emergency time when potable water is immediately demanded to be secured or in a case where natural water such as spring water or well water is used as the for-treatment water.

In particular, in a case where natural water such as the spring water or the well water is used as the for-treatment water, the treatment mode is selected in which the only organic substance removal treatment means including one or both of the means for removing the organic substances by the adsorption using the carbon fiber and the means for removing the organic substances by use of the filter film is operated. In consequence, the peculiar flavor of the natural water itself and the like can be maintained to make safe water.

Moreover, in the invention of the tenth aspect, the invention according to any one of the fourth to ninth aspects has the treatment mode to operate the inorganic substance removal treatment means and the mineral addition treatment means in a state in which the organic substance removal treatment means is not operated with respect to the for-treatment water. Therefore, for example, in a case where water such as tap water already subjected to the removal treatment of the organic substances and the germs is used as the for-treatment water, the inorganic substance removal treatment means once removes the inorganic substances from the tap water, and then the mineral addition treatment means only adds the mineral components, whereby the tap water can be treated into the safe and good water.

In the invention of the eleventh aspect, the invention according to any one of the fourth to tenth aspects further comprises: the storage means for receiving the for-treatment water obtained in a case where one or all of the treatment means performs the treatment function or all the treatment means does not perform the treatment function; and the circulation circuit which circulates the for-treatment water received in this storage means between the storage means and the organic substance removal treatment means. Therefore, for example, in a case where as in the thirteenth aspect, the device has the treatment mode to supply the for-treatment water to the circulation circuit and to selectively operate the organic substance removal treatment means including one of the means for adsorptive removal the organic substances by use of the carbon fiber and the means for removing the organic substances by use of the filter film, the for-treatment water received in the storage means can be treated by the organic substance removal treatment means. In consequence, the hygiene and safety of the for-treatment water received in the storage means can be secured.

Moreover, according to the invention of the twelfth aspect, in the invention of the eleventh aspect, the storage means is interposed between the inorganic substance removal treatment means as well as the organic substance removal treatment means and the mineral addition treatment means. In this case, the for-treatment water is received in the storage means, and the for-treatment water received in the storage means is fed as much as an amount required by a user to the mineral addition treatment means immediately before the water is fed to the user, whereby the desired amount of the mineral components can be added to the water. In consequence, the water including the mineral components can be fed as much as the amount required by the user.

According to the invention of the fourteenth aspect, the invention according to any one of the first to thirteenth aspects further comprises: the water content collection means for collecting the water content included in the air, and the water collected by this water content collection means is the for-treatment water. Therefore, for example, in a case where as in the fifteenth aspect, the water content collection means is constituted of the evaporator having the refrigeration cycle constituted of the compressor, the radiator, the pressure reduction unit and the evaporator or the adsorbent configured to adsorb and discharge the water content, even in a district or a situation where it is difficult to obtain the water as in a desert district or a disaster district, the water content is collected from the air, and the collected water content can be treated into potable water.

According to the invention of the sixteenth aspect, the invention according to any one of the first to fourteenth aspects further comprises: the ice generation means for freezing water, and the water obtained by melting the ice generated by this ice generation means is the for-treatment water. Therefore, the concentration of impurities contained in the water, for example, dust, cations and scales can be lowered. In particular, the inorganic substance removal treatment of the inorganic substance removal treatment means and the organic substance removal treatment of the organic substance removal treatment means can smoothly be performed. Moreover, the durability of the inorganic substance removal treatment means or the organic substance removal treatment means can be improved.

### BRIEF DESCRIPTION OF THE DRAWINGS

FIG. 1 is a schematic explanatory diagram of a water feed device according to one embodiment of the present invention (Embodiment 1);

FIG. 2 is a schematic diagram of the water feed device according to the embodiment of the present invention;

FIG. 3 is an explanatory view of mineral addition treatment means shown in FIG. 1;

FIG. 4 is a flow chart showing the flow of for-treatment water in each treatment mode of the present embodiment;

FIG. 5 is a diagram showing the mineral content addition control operation of the mineral addition treatment means;

FIG. 6 is a schematic explanatory diagram of a water feed device according to another embodiment of the present invention (Embodiment 2);

FIG. 7 is a flow chart showing the flow of for-treatment water in each treatment mode of the present embodiment;

FIG. 8 is an inner constitution diagram of a water feed device according to another embodiment of the present invention (Embodiment 3);

FIG. 9 is an inner constitution diagram of a water feed device according to still another embodiment of the present invention (Embodiment 4); and

FIG. 10 is a diagram showing data concerning the mineral component ratio and the conductivity of mineral water written in the memory of control means in the water feed device of the present embodiment.

### DETAILED DESCRIPTION OF THE PREFERRED EMBODIMENT

Embodiments of the present invention will hereinafter be described in detail with reference to the drawings.

### Embodiment 1

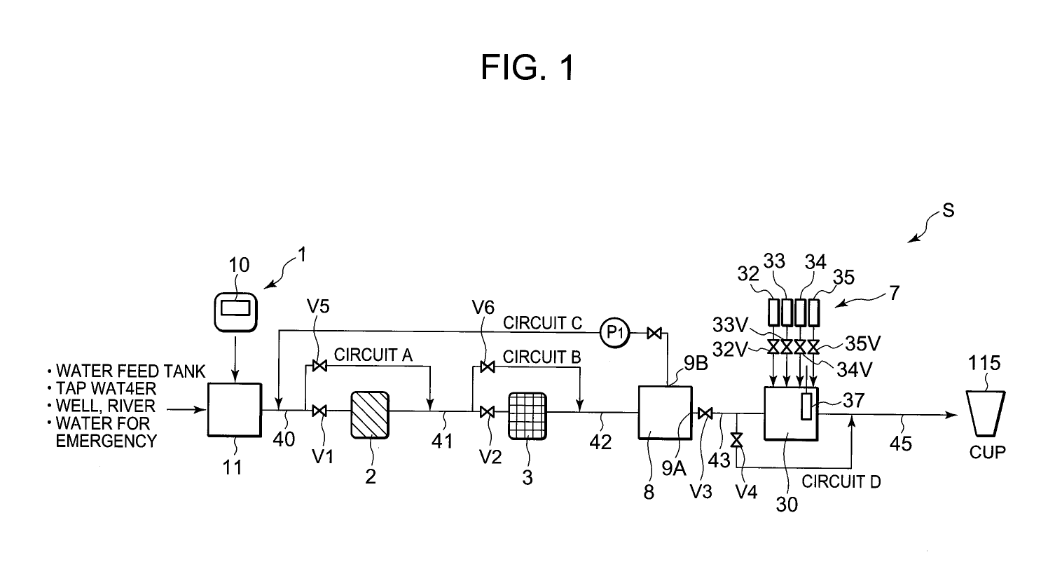

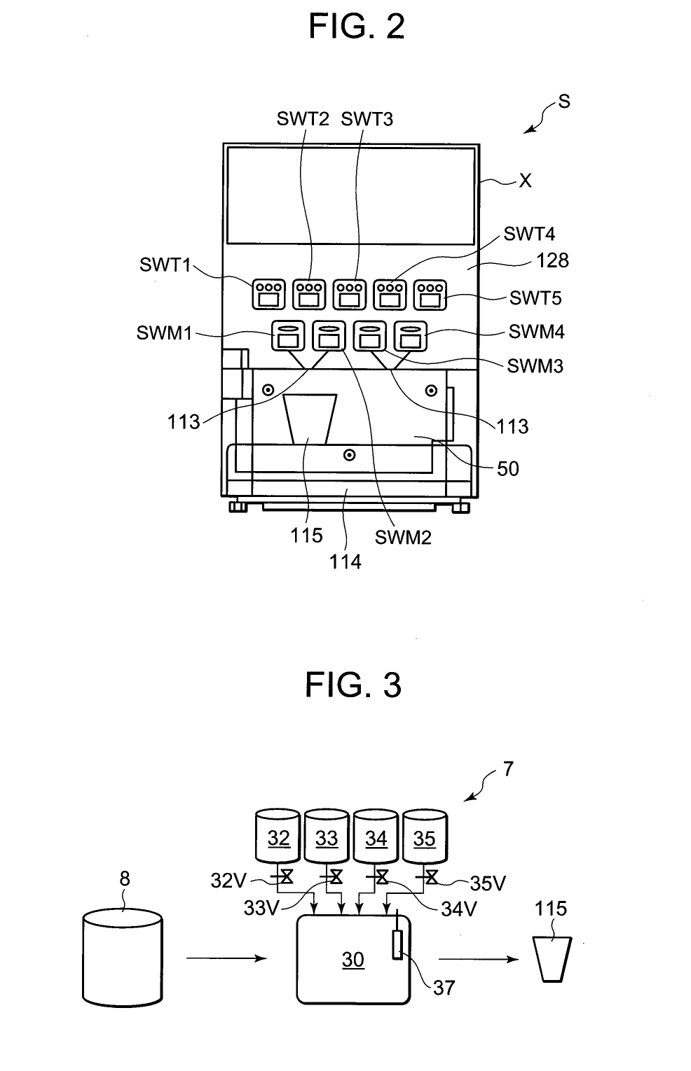

FIG. 1 shows a schematic explanatory diagram of a water feed device according to one embodiment of the present invention, and FIG. 2 shows a schematic diagram of the water feed device according to the embodiment of the present invention. This water feed device is a device which removes, from for-treatment water, inorganic substances including cations, dust and impurities such as the scales of these cations and dust, and organic substances such as germs to treat the water into potable water and which adds the desired amount of mineral components to this water to make and feed mineral water. A water feed device S of the present embodiment is constituted of water content collection means 1 for collecting a water content included in air, inorganic substance removal treatment means 2, organic substance removal treatment means 3, mineral addition treatment means 7, a storage tank 8 and the like.

The water content collection means 1 is means for collecting the water content included in the air. The water content collection means 1 of the present embodiment is a rotary dehumidifier including an adsorbent (a hygroscopic substance) 10 capable of adsorb and discharge the water content, a blower (not shown) and the like. The adsorbent 10 is constituted of a material such as silica, silica gel or zeolite having properties that the material adsorbs the water content at ordinary temperature (or the ordinary temperature or less) and that the material is heated to discharge the water content. The adsorbent is constituted by forming this material into a disc-like shape having a predetermined thickness. The adsorbent 10 is arranged so that a blowing direction from the blower (not shown) is substantially parallel to the axial center direction of the adsorbent 10. Moreover, an air passage (not shown) is provided around the adsorbent 10, and the air passage is divided into a first air passage and a second air passage by a passage partition plate. Then, the portion of the adsorbent 10 positioned in the first air passage is a water content adsorption region, and the portion of the adsorbent 10 positioned in the second air passage is a water content discharge region.

The blower supplies air from the outside of the water content collection means 1 to the water content adsorption region of the adsorbent 10, and then discharges the air from the water content collection means 1.

A part of the adsorbent 10 is noted. In a case where the adsorbent is rotated by an electric motor, a cycle is repeated where the part of the adsorbent moves from the water content adsorption region to the water content discharge region and returns to the water content adsorption region again. It is to be noted that in the water content discharge region, the water content adsorbed in the water content adsorption region is discharged. For example, it is constituted that the air heated by a heater or the like is supplied through the water content discharge region of the adsorbent 10, and then discharged to a condensing section such as a heat exchanger by blowing means (not shown). This condensing section cools and condenses air including a large amount of the water content adsorbed by the water content adsorption region, and the water condensed by the condensing section is collected in a water tank 11 provided right under the condensing section.

According to the above constitution, the water content in the air can be adsorbed in the water content adsorption region of the adsorbent 10, and the water content discharged from the adsorbent 10 in the water content discharge region can be condensed in the condensing section and collected in the water tank 11.

It is to be noted that the water content collection means 1 of the present embodiment collects the water content from the air by use of the rotary dehumidifier including the adsorbent (the hygroscopic substance) 10 capable of adsorbing and discharging the water content, but the water content collection means 1 is not limited to the above constitution. The water content collection means may be constituted of, for example, an evaporator having a refrigeration cycle including a compressor, a radiator, a pressure reduction unit and the evaporator. The water content collection means may be constituted so that the air is blown from the outside of the water content collection means 1 to the evaporator to condense and collect the water content in the air by the heat absorbing function of a refrigerant in such an evaporator.

On the other hand, the water tank 11 is a receiving section for receiving water (condensed water) collected from the air by the above water content collection means 1. The tank also performs a function as a storage section for temporarily receiving, in the water feed device S, water (e.g., tap water, water from a well or a river, water for emergency, water received in the water feed tank, etc.) introduced from the outside in addition to the water collected from the water content by the water content collection means 1. The water (hereinafter referred to as the for-treatment water) in this water tank 11 is fed to the inorganic substance removal treatment means 2, the organic substance removal treatment means 3, the mineral addition treatment means 7 or the storage tank 8 as described later.

The inorganic substance removal treatment means 2 removes the inorganic substances contained in the for-treatment water. Here, the inorganic substances mentioned in the present invention are not only the dust contained in the for-treatment water but also cations (especially, the ions of metals such as copper and aluminum), and the dust and cations precipitated as scales (scale components). Furthermore, the inorganic substances are the constituent substances of the adsorbent 10 mixed in a process in which the water passes through the adsorbent 10 of the water content collection means 10 in a case where the water collected as the for-treatment water by the water content collection means 1 is used. Examples of the constituent substances include fine powder of zeolite in a case where the adsorbent 10 is made of zeolite. Moreover, the inorganic substances are impurities of a metal constituting the evaporator (in the evaporator, the metal constituting the evaporator is sometimes dissolved in the for-treatment water) and the like in a case where the water content collection means 1 is constituted of the evaporator of the refrigeration cycle.

The inorganic substance removal treatment means 2 includes one or all of means for removing the inorganic substances by use of a carbon fiber (CF), means for removing the inorganic substances by use of the adsorbent and means for removing the inorganic substances by use of a reverse osmosis membrane. The means for removing the inorganic substances by use of the carbon fiber includes a water tank which receives the for-treatment water, and electrodes made of the carbon fiber. The electrodes are immersed into the water tank in which the for-treatment water is received, and a potential is applied to the electrodes, whereby the inorganic substances in the for-treatment water are positively adsorbed by the electrodes.

The means for removing the inorganic substances by use of the adsorbent includes at least a material which adsorbs the inorganic substances. The for-treatment water is brought into contact with the adsorbent, whereby the inorganic substances in the for-treatment water are adsorbed and removed from the for-treatment water. Moreover, the means using the reverse osmosis membrane is constituted of a water tank for receiving the for-treatment water, the reverse osmosis membrane and the like. Specifically, the means includes, for example, membrane bodies which form front and back surfaces, a frame body which surrounds the peripheries of the membrane bodies, and a water outlet surrounded by this frame body and thus opened in a space formed between both the membrane bodies. The membrane bodies are reverse osmosis membranes provided with micro holes having predetermined diameters or less, and can pass only water without passing any inorganic substance contained in the for-treatment water. In consequence, when a pressure higher than an osmotic pressure is added, the inorganic substances in the for-treatment water are separated by the membrane bodies, the only water can pass through the membrane bodies, and the water can be taken from the water output opened between the membrane bodies.

The inorganic substance removal treatment means 2 of the present embodiment includes means for removing the inorganic substances by use of the carbon fiber (CF). The treatment using the carbon fiber also has a function of removing the organic substances in addition to the inorganic substances. Therefore, in a case where the inorganic substance removal treatment means 2 is constituted of the means using the carbon fiber, while the inorganic substances are treated, the organic substances can be treated to a certain degree. When the organic substance removal treatment means 3 described later is also operated, the organic substances can more securely remove the organic substances. It is to be noted that it has been described in the present embodiment that the inorganic substance removal treatment means 2 is constituted of the means using the carbon fiber, but the present invention is not limited to this constitution, and the inorganic substances may be removed using the adsorbent or the reverse osmosis membrane. Moreover, the inorganic substance removal treatment means of the present invention may be constituted of these two or more means, for example, the means for electrolyzing the inorganic substances by use of the carbon fiber and the means using the reverse osmosis membrane, or all of these means.

On the other hand, the organic substance removal treatment means 3 removes the organic substances contained in the for-treatment water, that is, sterilizes or removes the germs and the like contained in the for-treatment water. The organic substance removal treatment means 3 is constituted of one or both of means for removing the organic substances by use of the carbon fiber and means for removing the organic substances by use of a filter film (corresponding to germ removal, in this case).

The means for removing the organic substances by use of the carbon fiber includes a water tank in which the for-treatment water is received and electrodes made of the carbon fiber. The electrodes are immersed into the water tank in which the for-treatment water is received, and a potential is applied to the electrodes with a low current value to such a degree that electrolysis is not caused, whereby the organic substances in the for-treatment water are positively adsorbed by the electrodes made of the carbon fiber (the germ removal).

Moreover, the means using the filter film includes a water tank in which the for-treatment water is received, and the filter film, and the means subjects the for-treatment water to a filtering treatment by the filter film to separate the germs and the like from the for-treatment water (the germ removal).

The organic substance removal treatment means 3 of the present embodiment is constituted of one of the means for adsorptive removal the organic substances by use of the carbon fiber and the means using the filter film.

On the other hand, the mineral addition treatment means 7 has at least one of mineral components such as magnesium, calcium, potassium, sodium and silica, and adds the mineral component to the for-treatment water to feed the water. As shown in FIGS. 1 and 3, the mineral addition treatment means 7 of the present embodiment is constituted of a water tank 30 which receives the for-treatment water, a tank 32 which receives a calcium chloride (CaCl₂) solution, a tank 33 which receives a sodium bicarbonate (NaHCO₃) solution, a tank 34 which receives a potassium bicarbonate (KHCO₃) solution and a tank 35 which receives a magnesium sulfide (MgSO₄) solution. The tanks 32 to 35 and the water tank 30 are connected to one another via pipes, respectively, and the opening and closing operation of electromagnetic valves 32V, 33V, 34V and 35V provided on the pipes can be performed to feed the solutions into the water tank 30, respectively.

That is, in the present embodiment, the respective mineral components are received as the solutions containing the mineral components in the tanks 32 to 35, and the solutions in the tanks 32 to 35 can be fed into the water tank 30 to add the mineral components to the for-treatment water in the water tank 30. Specifically, the calcium chloride solution received in the tank 32 can be fed to the for-treatment water in the water tank 30 to add a calcium component to the for-treatment water received in the water tank 30. Then, the sodium bicarbonate solution received in the tank 33 can be fed to the for-treatment water in the water tank 30 to add a sodium component to the for-treatment water in the water tank 30.

Similarly, the potassium bicarbonate solution received in the tank 34 can be fed to the for-treatment water in the water tank 30 to add a potassium component to the for-treatment water in the water tank 30. Furthermore, the magnesium sulfide solution received in the tank 35 can be fed to the for-treatment water in the water tank 30 to add a magnesium component to the for-treatment water in the water tank 30. It is to be noted that in the embodiment, the opening and closing operation of the electromagnetic valves 32V, 33V, 34V and 35V can be performed to feed the solutions into the water tank 30, but this is not restrictive. It may be constituted that the solutions in the tanks 32 to 35 can be fed into the water tank 30 with a water head pressure or a pneumatic pressure or by a pump.

In addition, when the mineral components are added to the for-treatment water, at least the generation of precipitation in the for-treatment water needs to be avoided. That is, the solutions need to be added to the for-treatment water in such an order that the generation of the precipitation can be avoided or from a portion where the generation of the precipitation can be avoided. Specifically, in the present embodiment, when the calcium chloride solution and the magnesium sulfide solution of the above four types of solutions react with each other, the precipitation might occur, and the for-treatment water might become turbid. Therefore, at least the calcium chloride solution and the magnesium sulfide solution are preferably added at separate timings, if possible. Alternatively, the solutions are preferably added to the for-treatment water in the water tank 30 from portions disposed away from each other, if possible, to avoid the generation of the precipitation.

Specifically, in the present embodiment, as shown in FIG. 1, the tank 32 in which the calcium chloride solution is received is arranged in a position away from the tank 35 in which the magnesium sulfide solution is received. Moreover, the opening of the pipe connecting the tank 32 to the tank 30 on the side of the tank 30 is provided on the side of one end of the tank 30 (on the side of the right end in FIGS. 1 and 3). Furthermore, the opening of the pipe connecting the tank 35 to the tank 30 on the side of the tank 30 is provided on the side of the other end of the tank 30 (on the side of the left end of FIGS. 1 and 3). In addition, the one solution is added to the for-treatment water in the order separate from the order in which the other solution is added. In the present embodiment, the calcium chloride solution, the sodium bicarbonate solution, the potassium bicarbonate solution and the magnesium sulfide solution are added to the for-treatment water in the water tank 30 in this order.

On the other hand, as conductive measurement means for measuring the conductivity of the for-treatment water, a conductivity meter 37 is installed in the water tank 30, and this conductivity meter 37 is connected to control means. Then, the control means controls the amounts of the mineral-component-containing solutions to be added from the tanks 32 to 35 so that the conductivity of the for-treatment water detected by the conductivity meter 37 is a predetermined conductivity set beforehand.

Specifically, the control means opens or closes the electromagnetic valves 32V, 33V, 34V and 35V, adds the predetermined amounts of the solutions to the for-treatment water in the water tank 30, and controls the amounts so that the conductivity of the for-treatment water detected by the conductivity meter 37 is the predetermined conductivity set beforehand. An operation for controlling the addition of the mineral components to the for-treatment water in this manner will be described later in detail.

It is to be noted that it has been described in the present embodiment that the calcium chloride solution is received in the tank 32, the magnesium sulfide solution is received in the tank 33, the sodium bicarbonate solution is received in the tank 34, the potassium bicarbonate solution is received in the tank 35, and the solutions are added to the for-treatment water in the water tank 30 from the tanks 32 to 35, whereby mineral components such as calcium, sodium, potassium and magnesium are added to the for-treatment water. However, when a mineral component other than the above components is added, a solution including the mineral component is further received in another tank, and the tank is supplied to the for-treatment water in the water tank 30 in the same manner as in the above solutions. In consequence, the other mineral component can be added to the for-treatment water. Moreover, as the above mineral components, in addition to the above solutions, the other solutions containing the mineral components may be applied. Even in this case, the mineral component needs to be added in such an order and from such a portion that at least the precipitation due to the addition of the mineral component does not occur in the for-treatment water.

Moreover, as described above, the mineral addition treatment means 7 of the present embodiment receives the solutions including the mineral components in the tanks 32 to 35, and feeds the solutions of the tanks 32 to 35 into the water tank 30, to add the mineral components to the for-treatment water in the water tank 30. However, the mineral addition treatment means of the present invention is not limited to this embodiment. For example, each of the mineral components is formed into a tablet-like shape, and this table may be added to the for-treatment water. Even in this case, as described above, the tablet needs to be added in such an order and from such a portion that the precipitation does not occur in the for-treatment water.

In addition, the water feed device S of the present embodiment is provided with the inorganic substance removal treatment means 2 and the organic substance removal treatment means 3 in the previous stage of the mineral addition treatment means 7, and the for-treatment water successively flows through the inorganic substance removal treatment means 2, the organic substance removal treatment means 3 and the mineral addition treatment means 7. That is, a pipe 40 connected to the outlet of the water tank 11 is connected to the inlet side of the inorganic substance removal treatment means 2, and a pipe 41 connected to the outlet side of the inorganic substance removal treatment means 2 is connected to the inlet side of the organic substance removal treatment means 3. Then, a pipe 42 connected to the outlet side of the organic substance removal treatment means 3 is connected to the inlet of the storage tank 8. Moreover, a pipe 43 connected to a taking port 9A is connected to the inlet side of the mineral addition treatment means 7 (an inlet provided on one side of the water tank 30), and the for-treatment water successively flows through the inorganic substance removal treatment means 2, the organic substance removal treatment means 3 and the mineral addition treatment means 7, respectively, as described above.

Furthermore, the water feed device S of the present embodiment is provided with bypass circuits for bypassing the respective treatment means (the inorganic substance removal treatment means 2, the organic substance removal treatment means 3 and the mineral addition treatment means 7), respectively. That is, in FIG. 1, a circuit A is a bypass circuit for bypassing the inorganic substance removal treatment means 2 to supply the for-treatment water from the water tank 11, one end of the bypass circuit A is connected to the middle portion of the pipe 40 on the inlet side of the inorganic substance removal treatment means 2, and the other end of the circuit is connected to the middle portion of the pipe 41 on the outlet side of the inorganic substance removal treatment means 2.

A circuit B is a bypass circuit for bypassing the organic substance removal treatment means 3 to supply the for-treatment water, and one end of the bypass circuit B is connected to the middle portion of the pipe 41 on the inlet side of the organic substance removal treatment means 3 in a position on the downstream side (i.e., the organic substance removal treatment means 3 side) from the connection point of the other end of the bypass circuit A (i.e., the organic substance removal treatment means 3 side). Then, the other end of the bypass circuit B is connected to the middle portion of the pipe 42 on the outlet side of the organic substance removal treatment means 3. Moreover, a circuit D is a bypass circuit for bypassing the mineral addition treatment means 7 to supply the for-treatment water, and one end of the bypass circuit D is connected to the middle portion of the pipe 43 on the inlet side of the mineral addition treatment means 7. The other end of the bypass circuit D is connected to the middle portion of a pipe 45 on the outlet side of the mineral addition treatment means 7.

These bypass circuits A, B and D and the pipes 40, 41 and 43 are provided with electromagnetic valves V1, V2, V3, V4, V5 and V6 as flow path control means for controlling whether to supply the for-treatment water to the treatment means (the inorganic substance removal treatment means 2, the organic substance removal treatment means 3 and the mineral addition treatment means 7) or the bypass circuits A, B and D. The opening and closing of the valves are controlled by the control means.

On the other hand, the above storage tank 8 is storage means for receiving the for-treatment water obtained in a case where one of the inorganic substance removal treatment means 2, the organic substance removal treatment means 3 and the mineral addition treatment means 7 performs a treatment function or all the treatment means (the inorganic substance removal treatment means 2, the organic substance removal treatment means 3 and the mineral addition treatment means 7) perform the treatment function or in a case where all the treatment means (the inorganic substance removal treatment means 2, the organic substance removal treatment means 3 and the mineral addition treatment means 7) do not perform the treatment function.

This storage tank 8 is interposed between the inorganic substance removal treatment means 2 as well as the organic substance removal treatment means 3 and the mineral addition treatment means 7. That is, the water feed device S of the present embodiment is constituted to feed the for-treatment water to the mineral addition treatment means 7 through the storage tank 8. Therefore, the storage tank 8 of the present embodiment is storage means for receiving the for-treatment water obtained in a case where one of the inorganic substance removal treatment means 2 and the organic substance removal treatment means 3 performs the treatment function or both the treatment means (the inorganic substance removal treatment means 2 and the organic substance removal treatment means 3) perform the treatment function, or in a case where both the treatment means (the inorganic substance removal treatment means 2 and the organic substance removal treatment means 3) do not perform the treatment function.

Specifically, an inlet formed on one side of the storage tank 8 is connected to the pipe 42, and the pipe 42 feeds, into the storage tank 8, the for-treatment water obtained in a case where one of the inorganic substance removal treatment means 2 and the organic substance removal treatment means 3 performs the treatment function, both the inorganic substance removal treatment means 2 and the organic substance removal treatment means 3 perform the treatment function, or both the inorganic substance removal treatment means 2 and the organic substance removal treatment means 3 do not perform the treatment function. Moreover, the storage tank 8 is provided with two taking ports 9A, 9B on the other side, and the taking port 9A is connected to the pipe 43 provided with the electromagnetic valve 43. The electromagnetic valve V3 is opened to feed the for-treatment water from the storage tank 8 to the mineral addition treatment means 7 through the pipe 43.

On the other hand, the taking port 9B is connected to one end of the circulation circuit C. The circulation circuit C is a circuit for circulating the for-treatment water received in the storage tank 8 between the storage tank 8 and the organic substance removal treatment means 3, and the other end of the circulation circuit C is connected to the middle portion of the pipe 40 on the inlet side of the inorganic substance removal treatment means 2 in a position on the upstream side (the water tank 11 side) from the connection point of the one end of the bypass circuit A.

The circulation circuit C is provided with a pump P1 for pumping up the for-treatment water from the storage tank 8. This pump P1 is connected to control means, and the control means controls the operation.

The water feed device S of the present embodiment having the above constitution is stored in, for example, a main body X shown in FIG. 2. From the upside to the downside in the main body X, the water content collection means 1, the water tank 11, the inorganic substance removal treatment means 2, the organic substance removal treatment means 3, the storage tank 8, the storage tank 8 and the mineral addition treatment means 7 are successively arranged.

Then, a potable water taking port 50 for taking the treated water is formed under the main body X. When, for example, one of water selection switches SWM1 to SWM4 provided on the front surface of an opening/closing door 128 of the main body X is operated, the potable water is fed to a cup 115 arranged on a table 114 which is the bottom part of the potable water taking port 50, through the pipe 45 and a nozzle 113. These water selection switches SWM1 to SWM4 are selection means for selecting whether or not the mineral addition treatment means 7 performs the treatment function with respect to the for-treatment water.

Specifically, the water selection switches SWM1, SWM2 and SWM3 are switches for selecting the amount of the mineral component to be added to the for-treatment water, and the switches are provided in accordance with the data of the control means concerning the mineral component of one or more types (three types in the present embodiment as described above) of mineral water.

For example, in the present embodiment, the switch SWM1 is a switch for selecting mineral water 1, the switch SWM2 is a switch for selecting mineral water 2, and the switch SWM3 is a switch for selecting mineral water 3.

Based on the operations of the respective switches SWM1 to SWM3, the control means adds the mineral components corresponding to the selected switches SWM1 to SWM3 to the for-treatment water received in the storage tank 8 to blend the mineral water 1 to 3, and feeds the water to the cup 115 arranged on the table 114 under the main body X through the pipe 45 and the nozzle 113. On the other hand, the switch SWM4 is a switch for selecting the water fed in a case where the mineral addition treatment means 7 does not perform the treatment function with respect to the for-treatment water, that is, the water to which any mineral component has not been added. When the switch SWM4 is operated, the control means opens the electromagnetic valve V4 of the bypass circuit D to supply the for-treatment water from the storage tank 8 to the bypass circuit D, and feeds the water to the cup 115 arranged on the table 114 under the main body X through the pipe 45 and the nozzle 113.

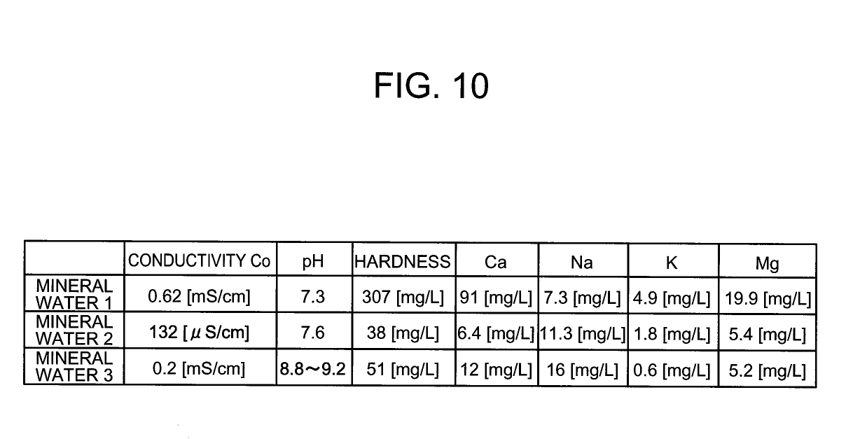

In addition, the control means of the present embodiment controls the addition of the mineral component by the mineral addition treatment means 7 based on the conductivity of the for-treatment water, and blends a plurality of types (three types in the embodiment) of water containing the mineral components, that is, the mineral water 1 to mineral water 3 as described above. For example, the data concerning the mineral component ratios of a plurality of types (three types in the embodiment) of brand-name spring water (mineral water) produced all over the world as shown in FIG. 10 is beforehand written in a memory of the control means. In accordance with the selection of the switches SWM1 to SWM3, the data is read from the memory, and the predetermined amounts of the mineral components to be added are added until the conductivity of the for-treatment water becomes the read conductivity of the mineral water. It is to be noted that an operation of the control means for controlling the addition of the mineral component will be described later in detail.

On the other hand, a plurality of (five in the present embodiment) treatment function selecting switches SWT1, SWT2, SWT3, SWT4 and SWT5 are installed right above the selection switches SWM1 to SWM4 on the front surface of the opening/closing door 128. The treatment function selecting switches SWT1, SWT2, SWT3, SWT4 and SWT5 are selection means for selecting whether or not the inorganic substance removal treatment means 2 and the organic substance removal treatment means 3 perform the treatment function with respect to the for-treatment water. The treatment function selecting switches SWT1 to SWT5 are connected to the control means in the same manner as in the switches SWM1 to SWM3.

In the present embodiment, for example, the switch SWT1 is a switch for selecting a treatment mode in a case where the water content collected from the air by the water content collection means 1 is used as the for-treatment water. When this switch SWT1 is selected, the control means controls the operations of the treatment means and the opening/closing of the electromagnetic valves so that the for-treatment water is subjected to the water content collection by the water content collection means 1 and the treatment functions of the inorganic substance removal treatment means 2 and the organic substance removal treatment means 3.

Moreover, the switch SWT3 is a switch for selecting a treatment mode in a case where natural water such as spring water or well water is used as the for-treatment water. When this switch SWT3 is selected, the control means controls the operations of the treatment means and the opening/closing of the electromagnetic valves so that the for-treatment water is not subjected to the treatment function of the inorganic substance removal treatment means 2 and is only subjected to the treatment function of the organic substance removal treatment means 3.

Then, the switch SWT4 is a switch for selecting a treatment mode in a case where water subjected to a sterilization or germ removal treatment, for example, tap water is used as the for-treatment water. When this switch SWT4 is selected, the control means controls the operations of the treatment means and the opening/closing of the electromagnetic valves so that the for-treatment water is not subjected to the treatment function of the organic substance removal treatment means 3 and is subjected to the treatment function of the inorganic substance removal treatment means 2.

Furthermore, the switch SWT5 is a switch for selecting a treatment mode for circulating the for-treatment water received in the storage tank 8 between the storage tank 8 and the organic substance removal treatment means 3. When this switch SWT5 is selected, the control means controls the operations of the treatment means, the opening/closing of the electromagnetic valves and the operation of the pump P1 so that the for-treatment water received in the storage tank 8 is supplied to the organic substance removal treatment means 3 and subjected to the treatment function of the organic substance removal treatment means 3.

It is to be noted that the switch SWT2 is a switch for selecting a treatment mode for emergency. When this switch SWT2 is selected, the treated water is fed without operating the above switches SWM1 to SWM4. That is, in a case where the switch SWT2 is selected, the control means controls the operations of the treatment means and the opening/closing of the electromagnetic valves so that the for-treatment water is not subjected to the treatment functions of the inorganic substance removal treatment means 2 and the organic substance removal treatment means 3, and is subjected to the water content collection by the water content collection means 1 and the treatment function of the organic substance removal treatment means 3. A specific operation will be described in detail in the following operation description.

Next, the operation of the water feed device S of the present embodiment having the above constitution will be described in detail. When the treatment mode is selected in accordance with the type of the for-treatment water to be used by a user, a use situation and the like, the control means controls the operations of the treatment means, the electromagnetic valves and the like in accordance with the treatment mode.

(1) Treatment Mode in which the Water Collected from the Air is Used as the for-Treatment Water:

First, an operation in a case where the treatment function selecting switch SWT1 is selected will be described.

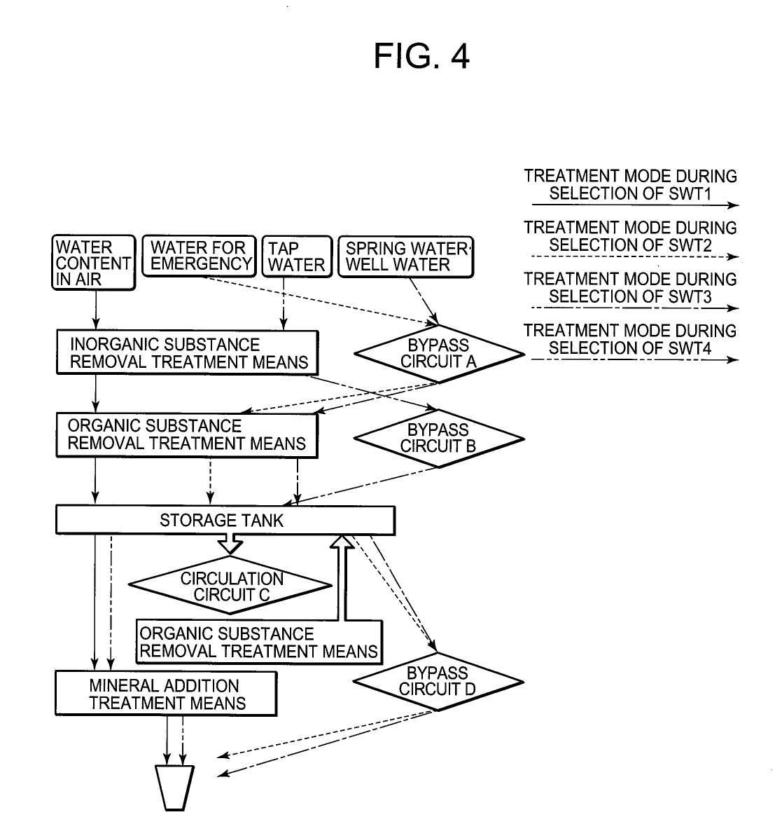

In this case, the water content collection means 1 collects the water content from air, and this collected water content is used as the for-treatment water. When the treatment mode is selected (selected by the switch SWT1), the control means fully closes the respective electromagnetic valves V5, V6 provided in the bypass circuits A, B, and opens the electromagnetic valve V1 of the pipe 40 and the electromagnetic valve V2 of the pipe 41. In consequence, as shown by solid-line arrows in FIG. 4, the for-treatment water collected from the water content collection means 1 to the water tank 11 does not bypass the inorganic substance removal treatment means 2 and the organic substance removal treatment means 3, and successively passes through the inorganic substance removal treatment means 2. Moreover, the control means starts the operations of the water content collection means 1, the inorganic substance removal treatment means 2 and the organic substance removal treatment means 3.

In consequence, the air outside the water feed device S is blown to the collection means 1 by the blower, and the air is discharged from the device through the first air passage and the water content adsorption region of the adsorbent 10. At this time, the water content included in the air is adsorbed by the adsorbent 10 of a portion constituting the water content adsorption region, and the adsorbent is rotated by the electric motor to convey the water content to the water content discharge region. Then, the blowing means is operated to discharge, to the condensing section, the air heated to a high temperature (e.g., +140° C.) by a heater through the water content discharge region of the adsorbent 10. In consequence, the air heated by the heater receives the water content adsorbed by the water content adsorption region of the adsorbent 10 in the water content discharge region of the adsorbent 10, and is then cooled and condensed in the condensing section. Then, the condensed water content is received in the water tank 11 positioned right under the condensing section. In consequence, the adsorbent 10 is rotated to continuously achieve the water content adsorption and discharge operations, so that the water can efficiently be collected from the air.

The water (the for-treatment water) once received in the water tank 11 successively passes through the inorganic substance removal treatment means 2 and the organic substance removal treatment means 3 positioned right under the water tank 11, and in this process, the above inorganic substances and organic substances such as the germs are removed. Thus, the inorganic substance removal treatment means 2 removes the dust included in the for-treatment water, the fine powder of zeolite and impurities such as the cations (especially, the metal ions) or cation scales, and the organic substance removal treatment means 3 removes the germs from the for-treatment water (the germ removal), whereby the for-treatment water can be treated into the safe and potable water. Then, the for-treatment water subjected to the germ removal treatment by the organic substance removal treatment means 3 is received in the storage tank 8.

(2) Treatment Mode in which Natural Water Such as the Spring Water or the Well Water is Used as the for-Treatment Water:

On the other hand, when water other than the water content collected from the air is used as the for-treatment water, the potable, good and safe water can sometimes be manufactured without subjecting the for-treatment water to all of the treatments of the inorganic substance removal treatment means 2, the organic substance removal treatment means 3 and the mineral addition treatment means 7. As one example, when natural water such as the spring water or the well water is used as the for-treatment water, tasty components inherent in the spring water or the well water itself are included, and hence the only germ removal treatment is preferably performed without removing any tasty component. Therefore, the water feed device S of the present invention includes a treatment mode in a case where the water including the tasty components, for example, the spring water or the well water is used as the for-treatment water. That is, in a case where the user selects the switch SWT3, a treatment is executed so that the inorganic substance removal treatment means 2 is not operated with respect to the for-treatment water, and the only organic substance removal treatment means 3 is operated.

First, the control means fully closes the electromagnetic valve V1 of the pipe 40, opens the electromagnetic valve V5 of the bypass circuit A, opens the electromagnetic valve V2 of the pipe 41, and fully closes the electromagnetic valve V6 of the bypass circuit B. In consequence, as shown by broken-line (one-dot broken-line) arrows in FIG. 4, the for-treatment water in the water tank 11 bypasses the inorganic substance removal treatment means 2 to pass through the organic substance removal treatment means 3.

Then, the water (the for-treatment water) fed from the outside to the water tank 11 and once received in the water tank 11 passes through the organic substance removal treatment means 3 via the bypass circuit A, and in this process, organic substances such as the germs are removed. In this case, the organic substance removal treatment means 3 is constituted of means for adsorptive removal the organic substances by use of the carbon fiber or means using the filter film, whereby organic substances such as the germs can be removed without impairing any flavor of the for-treatment water.

That is, when the organic substance removal treatment means 3 is constituted of means for generating hypochlorous acid, ozone or the like by electrolysis, hypochlorous acid or ozone has to be generated in the for-treatment water. Even when the minute amount of hypochlorous acid or ozone is generated, the tasty components of the for-treatment water are influenced, and the flavor might be impaired or deteriorated. However, as described above, the organic substance removal treatment means 3 is constituted of one or both of the means for adsorptive removal the organic substances by use of the carbon fiber and the means using the filter film, whereby the above-mentioned disadvantage can be avoided in advance. Then, the for-treatment water subjected to the germ removal treatment by the organic substance removal treatment means 3 is received in the storage tank 8.

(3) Treatment Mode where Water from which the Organic Substances have been Removed, for Example, the Tap Water or the Like is Used as the for-Treatment Water:

On the other hand, when the water other than the water content collected from the air, for example, the tap water is used as the for-treatment water, the tap water is already subjected to the sterilization or the germ removal, and the organic substances are removed. Therefore, the water does not have to be treated by the organic substance removal treatment means. That is, the inorganic substance removal treatment means once removes, from the tap water, all the inorganic substances including the cations (especially, the metal ions) which impair the flavor, and then the mineral addition treatment means merely adds mineral components such as magnesium, calcium, potassium, sodium and silica which are the tasty components of the water, whereby the tap water can be treated into the safe and good water. Therefore, the water feed device S of the present invention includes a treatment mode in a case where water from which the organic substances have been removed, for example, the tap water or the like is used as the for-treatment water. That is, when the user selects the switch SWT4, a treatment is executed corresponding to the water subjected to the organic substance removal treatment.

First, the control means opens the electromagnetic valve V1 of the pipe 40, closes the electromagnetic valve V5 of the bypass circuit A, closes the electromagnetic valve V2 of the pipe 41, and opens the electromagnetic valve V6 of the bypass circuit B. In consequence, as shown by broken-line (two-dot broken-line) arrows in FIG. 4, the for-treatment water in the water tank 11 passes through the inorganic substance removal treatment means 2, and then bypasses the organic substance removal treatment means 3.

Then, the water (the for-treatment water) fed from the outside to the water tank 11 and once received in the water tank 11 passes through the inorganic substance removal treatment means 2, and in this process, the dust included in the for-treatment water, the fine powder of zeolite, and impurities (inorganic substances) such as the cations (especially, the metal ions) and these scales are removed. Afterward, the for-treatment water is received in the storage tank 8 through the bypass circuit B.

### (4) Water Feed Operation

In addition, when one of the switches SWM1 to SWM4 is selected, the for-treatment water treated in each of the above treatment modes and received in the storage tank 8 is blended into the water corresponding to the switch selected from the switches SWM1 to SWM4, and the water is supplied to the cup 115 arranged on the table 114 through the pipe 45 and the nozzle 113.

In this case, when the switches SWM1 to SWM3 are selected, the control means supplies the water from the storage tank 8 to the mineral addition treatment means 7, and the mineral addition treatment means 7 adds the mineral components to prepare the mineral water. The control means controls the addition of the mineral components based on the conductivity of the mineral addition treatment means 7 detected by the conductivity meter 37 provided in the water tank 30. The conductivity of the water increases in proportion to the amount of the mineral components included in the water. Soft water has a low conductivity. As the hardness of the water increases, the conductivity increases.

Therefore, as described above, in the control means of the present embodiment, the data concerning the mineral component ratios of a plurality of types (three types in the embodiment) of brand-name spring water (mineral water 1, mineral water 2 and mineral water 3) produced all over the world as shown in FIG. 10 and the conductivities Co of the mineral water 1 to 3 are beforehand written in the memory of the control means. In accordance with the selection of the switches SWM1 to SWM3, the data and the conductivity Co are read from the memory, and the predetermined amounts of the mineral components to be added are added until a conductivity C becomes the read conductivity Co of the mineral water.

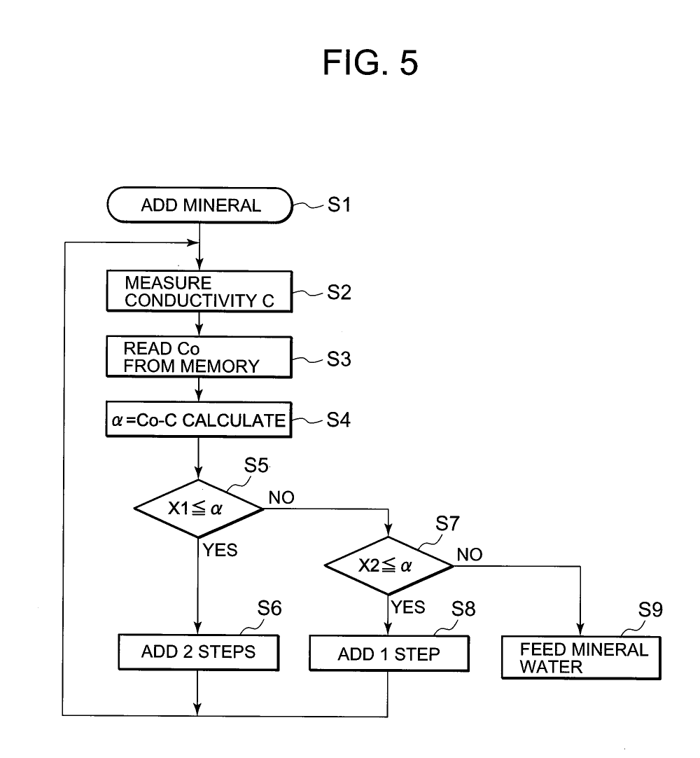

Here, an operation for controlling the addition of the mineral components by the control means will be described with reference to FIG. 5. FIG. 5 is a flow chart showing the mineral content addition control operation of the mineral addition treatment means 7. It is to be noted that the for-treatment water to be treated by the mineral addition treatment means 7 will be described as pure water from which all the mineral components of the for-treatment water have been removed by the inorganic substance removal treatment means 2 of the previous stage, that is, in which any ion is not present in the for-treatment water.

First, when the user operates one of the switches SWM1 to SWM3 for selecting the mineral water 1, 2 and 3, the control means opens the electromagnetic valve V3 of the pipe 43 for a predetermined short time. It is to be noted that at this time, the electromagnetic valve V4 of the bypass circuit D is closed. In consequence, the predetermined amount (e.g., 200 mL) of the for-treatment water received in the storage tank 8 is fed to the water tank 30 by, for example, user's switch operation (the operation of one of the switches SWM1 to SWM3).

Then, when the above predetermined amount (200 mL) of the for-treatment water is fed into the water tank 30, the control means starts the mineral addition control operation. First, in step S1 of FIG. 5, the control means reads the data concerning the mineral component ratio of the selected mineral water (one of the mineral water 1 to 3 in the present embodiment), and adds the predetermined amounts of the mineral components to be added beforehand set based on the data in such a predetermined order that any precipitation is not caused in the for-treatment water.

Specifically, a case where the user selects the mineral water 1 (i.e., a case where the selection switch SWM1 is operated) will be described as an example. As shown in FIG. 10, the selected mineral water contains, per 1 L, 91 mg of calcium, 7.3 mg of sodium, 4.9 mg of potassium and 19.9 mg of magnesium. Therefore, the control means performs the opening/closing operation of the electromagnetic valves 32V to 35V to control the electromagnetic valves 32V to 35V so that 18.2 mg of calcium, 1.46 mg of sodium, 0.98 mg of potassium and 3.98 mg or less of magnesium are added as the approximate amounts of the mineral components to 200 mL of pure water (the for-treatment water) in the water tank 30. The calcium chloride solution, the sodium bicarbonate solution, the potassium bicarbonate solution and the magnesium sulfide solution in the tanks 32 to 35 are added in this order.

In consequence, if the calcium chloride solution received in the tank 32 and the magnesium sulfide solution received in the tank 35 are added at timings close to each other, the precipitation is easily generated. However, the solutions can be added to the for-treatment water in the water tank 30 in separate order. Moreover, in the present embodiment, as described above, the calcium chloride solution and the magnesium sulfide solution are added to the for-treatment water in the water tank 30 from portions disposed away from each other. Therefore, it is possible to securely prevent a disadvantage that when the solutions including the mineral components are added to the for-treatment water in the water tank 30, the precipitation is caused in the for-treatment water and the for-treatment water becomes turbid. Thus, when the mineral component having an amount smaller than that of each of the mineral components included in the predetermined amount (200 mL in the present embodiment) of the mineral water 1 is added in the step S1, the conductivity C of the for-treatment water does not largely exceed the target value (i.e., Co) of the conductivity.

Next, the control means measures the conductivity C of the for-treatment water in the water tank 30 with the conductivity meter 37 in step S2, and then the control means shifts to step S3 to read the data Co of the conductivity stored in the memory in accordance with the selected switches SWM1 to SWM3, thereby shifting to step S4.

Then, in the step S4, the control means compares the conductivity C of the for-treatment water measured in the conductivity meter 37 with the read data Co of the conductivity. That is, in the step S4, the control means calculates a difference a between the read conductivity data Co and the conductivity C of the for-treatment water (i.e., α=Co−C), and shifts to step S5 to judge whether or not the difference α calculated in the step S4 is a preset value X1 or more (it is to be noted that the preset value X1 is a positive value larger than X2 as described later).

Here, when the difference α is larger than the value X1, the conductivity C of the for-treatment water in the water tank 30 is considerably smaller than the read data Co of the conductivity (i.e., this is the conductivity of the selected mineral water, and the mineral components are added to the for-treatment water so as to obtain the conductivity). Therefore, the control means shifts to step S6 to feed each of the solutions received in the tanks 32 to 35 into the water tank 30 as much as two steps. Specifically, the control means controls the electromagnetic valves 32V to 35V to add each of the calcium chloride solution, the sodium bicarbonate solution, the potassium bicarbonate solution and the magnesium sulfide solution of the tanks 32 to 35 as much as the two steps in this order. It is to be noted that the rise of the conductivity accompanying the addition for one step is beforehand measured to set the amount of each solution to be added as much as one step and the threshold values (the zones) X1, X2 so that the conductivity does not largely exceed a target value (i.e., Co).

For example, in a case where the amount of each mineral component to be added as much as one step is set to an amount which is 1/200 of the amount of each mineral component contained in the predetermined amount of the mineral water, in the step S6, the amount of the mineral component to be added as much as two steps is added. Therefore, the amount of each mineral component which is 1/100 of the amount of the mineral component contained in the predetermined amount of the mineral water is added. Here, a case where the mineral water 1 is selected and 200 mL of for-treatment water is fed into the water tank 30 will be described as an example. In the step S6, the control means controls the electromagnetic valves 32V to 35V so as to add 0.182 mg of calcium, 1.46×10⁻² mg of sodium, 0.98×10⁻² mg of potassium and 3.98×10⁻² mg of magnesium to 200 mL of for-treatment water in the water tank 30, and the control means adds the calcium chloride solution, the sodium bicarbonate solution, the potassium bicarbonate solution and the magnesium sulfide solution in this order.

Next, the control means returns from the step S6 to the step S2, measures the conductivity C of the for-treatment water in the water tank 30 with the conductivity meter 37, and successively performs the steps S3, S4 and S5. On the other hand, when the difference α is smaller than the value X1 owing to such addition of the mineral component in the step S5, the control means shifts to step S7 to judge whether or not the difference α calculated in the step S4 is a certain beforehand set value X2 (X2 is a positive value smaller than the value X1) or more.

Here, when the difference α is larger than the value X2, the control means shifts to step S8 to feed each of the solutions received in the tanks 32 to 35 as much as one step into the water tank 30. That is, as described above in the step S6, the control means controls the electromagnetic valves 32V to 35V to add each of the calcium chloride solution, the sodium bicarbonate solution, the potassium bicarbonate solution and the magnesium sulfide solution of the tanks 32 to 35 as much as one step in this order. Specifically, in the same manner as described above, the amount of each mineral component to be added as much as one step is set to the amount which is 1/200 of the amount of each mineral component contained in the predetermined amount of mineral water, the mineral water 1 is selected, and 200 mL of for-treatment water is fed into the water tank 30. This case will be described as an example. In this case, in the step S8, the control means controls the electromagnetic valves 32V to 35V so as to add, to 200 mL of for-treatment water in the water tank 30, 9.1×10⁻² mg of calcium, 7.3×10⁻³ mg of sodium, 4.9×10⁻³ mg of potassium and 1.99×10⁻² mg of magnesium, and the control means adds the calcium chloride solution, the sodium bicarbonate solution, the potassium bicarbonate solution and the magnesium sulfide solution in this order.

Thus, when the difference α is the value X1 or more, the solutions (the mineral components) are added from the tanks 32 to 35 as much as two steps, whereby the conductivity can be brought close to the target conductivity Co early. Moreover, when the difference α is smaller than the value X1 owing to the addition of the solutions (the mineral components), the difference α is compared with the value X2 smaller than the value X1. When the difference α is the value X2 or more, the mineral components are added as much as one step, whereby it is possible to avoid the disadvantage that the conductivity considerably exceeds the target conductivity Co.

On the other hand, when the difference α is less than the value X2 owing to such addition of the mineral components in the step S7, the control means shifts to step S9, opens an electromagnetic valve (not shown) provided in the water tank 30 or the pipe 45, and feeds the mineral water blended in the water tank 30 to the cup 115 on the table 114 in the potable water taking port 50 through the pipe 45 and the nozzle 113.

As described above, according to the water feed device S of the present embodiment, the mineral addition treatment means 7 adds the mineral components in accordance with the mineral water (one of the mineral water 1 to the mineral water 3) selected with the mineral component selection switches SWM1 to SWM3. Moreover, the addition of the mineral components by the mineral addition treatment means is controlled based on the conductivity of the for-treatment water, whereby the mineral water (the mineral water 1 to the mineral water 3) can be generated. In consequence, the mineral water having properties in accordance with the user's request can be generated, and versatility can be improved. In particular, when the amount of the mineral component to be added is controlled based on the conductivity of the for-treatment water as in the present embodiment, the amount of the mineral component to be added can easily be managed, and good water can more easily be made.

Furthermore, when the water collected from the air is the for-treatment water and the for-treatment water successively flows through the inorganic substance removal treatment means 2, the organic substance removal treatment means 3 and the mineral addition treatment means 7, the potable, good and safe water can be manufactured from the water content collected from the air.

Moreover, the inorganic substance removal treatment means 2 removes the inorganic substances, and then the mineral addition treatment means 7 adds the mineral components, whereby cations such as the metal ions which are harmful to human bodies can securely be removed to add the only necessary mineral components. In particular, the inorganic substance removal treatment means 2 can remove the inorganic substances from the for-treatment water to treat the for-treatment water into pure water in which any ion is not present. The mineral addition treatment means 7 of the subsequent stage can obtain an optimum state for making each mineral water based on the conductivity. Furthermore, the mineral addition treatment means 7 is provided in the subsequent stage (on the outlet side) of the organic substance removal treatment means 3. In consequence, especially when the organic substance removal treatment means 3 is an electrolytic treatment device, a disadvantage that an electrolytic treatment is adversely affected by the mineral addition can be avoided. That is, in a case where the mineral addition treatment means 7 is provided in the previous stage (on the inlet side) of the organic substance removal treatment means 3, even when the mineral components are added, the mineral components might be removed by the electrolytic treatment of the organic substance removal treatment means 3 positioned after the mineral addition treatment means 7. Moreover, the mineral components are attached to the electrodes, and this causes a disadvantage that the electrodes are deteriorated to lower performance and durability.

To solve the problem, as in the present embodiment, the mineral addition treatment means 7 is provided in the subsequent stage of the inorganic substance removal treatment means 2 and the organic substance removal treatment means 3, and the for-treatment water successively flows through the inorganic substance removal treatment means 2, the organic substance removal treatment means 3 and the mineral addition treatment means 7, whereby the above disadvantage can be eliminated, and the potable, good and safe water can be manufactured.

Furthermore, as in the present embodiment, the water feed device S is stored in the main body X, and the for-treatment water is configured to successively flow through the inorganic substance removal treatment means 2, the organic substance removal treatment means 3 and the mineral addition treatment means 7. Moreover, a path is constituted so that the for-treatment water flows downwards through these means from the upside to the downside. In this constitution, the water feed device S can smoothly treat the for-treatment water. In particular, as in the present embodiment, the respective means (the water content collection means 1, the inorganic substance removal treatment means 2, the organic substance removal treatment means 8 and the mineral addition treatment means 7) are constituted in the main body X, whereby the water feed device S can be miniaturized. In consequence, the versatility of the water feed device S can be improved.

On the other hand, in a case where the user selects the switch SWM4, the water which is not subjected to the mineral addition treatment of the mineral addition treatment means 7 is fed. This is suitable for a case where the water received in the storage tank 8 is, for example, natural water such as the spring water or the well water. When the switch SWM4 is selected, the control means opens the electromagnetic valve V4 of the bypass circuit D, and then opens the electromagnetic valve V3 of the pipe 43 for a predetermined short time. In consequence, the predetermined amount (e.g., an amount for one cup (200 mL) due to one operation of the switch SWM4 by the user) of the for-treatment water received in the storage tank 8 is fed from the pipe 43 to the cup 115 arranged on the table 114 in the potable water taking port 50, through the bypass circuit D, the pipe 45 and the nozzle 113.

### (5) Treatment Mode During Storage

In addition, when the for-treatment water received in the storage tank 8 as described above is stored in the storage tank 8 without being used for a long period, organic substances such as the germs might be propagated again in the for-treatment water. To solve the problem, the water feed device S of the present invention includes a treatment mode in which the for-treatment water received in the storage tank 8 is supplied to the circulation circuit C for circulating the water between the storage tank 8 and the organic substance removal treatment means 3, and the organic substance removal treatment means 3 removes the organic substances from the for-treatment water. That is, when the user selects the switch SWT5, the removal treatment of the organic substances in the for-treatment water received in the storage tank 8 is executed.

In the treatment mode, first, the control means fully closes the electromagnetic valve V1 of the pipe 40 and the electromagnetic valve V6 of the bypass circuit B, and opens the electromagnetic valve V5 of the bypass circuit A and the electromagnetic valve V2 of the pipe 41. Moreover, the operation of the pump P1 provided in the circulation circuit C is started. At this time, the electromagnetic valve V3 of the pipe 43 remains to be closed. In consequence, as shown by outline arrows in FIG. 4, the for-treatment water is pumped up from the storage tank 8 to the circulation circuit C by the pump P1 of the circulation circuit C, successively passes through the pipe 40 on the inlet side of the inorganic substance removal treatment means 2, the bypass circuit A, the pipe 41 and the organic substance removal treatment means 3, and then returns into the storage tank 8. This cycle is repeated.

When the control means starts the operation of the organic substance removal treatment means 3, the water (the for-treatment water) once received in the storage tank 8 is pumped up to the circulation circuit C by the operation of the pump P1. Then, the for-treatment water passes through the organic substance removal treatment means 3 from the circulation circuit C through the pipe 40, the bypass circuit A and the pipe 41, and in this process, organic substances such as the germs are removed. In consequence, the organic substances (the germs) generated in the for-treatment water can be removed to make the potable and safe water again.

Then, the for-treatment water subjected to the germ removal treatment of the organic substance removal treatment means 3 is received in the storage tank 8 again. Thus, in the present treatment mode, the for-treatment water in the storage tank 8 is supplied to the circulation circuit C, subjected to the germ removal treatment of the organic substance removal treatment means 3 and stored in the storage tank 8 for the long period. In consequence, organic substances such as the generated germs can be removed, and the water can be stored as the potable water again.

### (6) Treatment Mode for Emergency

In addition, as described above, the for-treatment water is successively supplied through the inorganic substance removal treatment means 2, the organic substance removal treatment means 3 and the mineral addition treatment means 7, and treated, whereby the potable, good and safe water can be manufactured. However, it is demanded that the potable water be made with a minimum treatment regardless of the taste of the water in a case where the potable water is to be immediately secured, for example, in a case where the present water feed device S is used in a disaster district or the like. To solve the problem, the water feed device S of the present invention includes a treatment mode for immediately securing the potable water in this manner. That is, when the user selects the switch SWT2, a treatment for emergency is executed.

First, the control means fully closes the electromagnetic valve V1 of the pipe 40, opens the electromagnetic valve V5 of the bypass circuit A, opens the electromagnetic valve V2 of the pipe 41 and fully closes the electromagnetic valve V6 of the bypass circuit B. Furthermore, the control means opens the electromagnetic valve V3 of the pipe 43 and the electromagnetic valve V4 of the bypass circuit D. In consequence, as shown by broken-line arrows in FIG. 4, the water for emergency (the for-treatment water) fed from the outside to the water tank 11 bypasses the inorganic substance removal treatment means 2 to pass through the organic substance removal treatment means 3, and then bypasses the mineral addition treatment means 7 via the storage tank 8.

Then, the water (the for-treatment water) in the water tank 11 from the outside passes through the organic substance removal treatment means 3 via the bypass circuit A, and in this process, organic substances such as the germs are removed. Furthermore, the for-treatment water subjected to the germ removal treatment by the organic substance removal treatment means 3 passes through the storage tank 8, the pipe 43 and the bypass circuit D, and is fed to the cup 115 arranged on the table 114 in the potable water taking port 50 through the pipe 45 and the nozzle 113. When this switch SWT2 is selected, regardless of the operations of the switches SWM1 to SWM3, the electromagnetic valve V3 of the pipe 43 is opened, and the for-treatment water in the storage tank 8 is fed to the cup 115 through the pipe 45 and the nozzle 113.

Thus, in the present treatment mode, the for-treatment water in the water tank 11 is supplied through the organic substance removal treatment means 3 only, whereby the potable water can be manufactured. Therefore, it is possible to cope with even a case where the potable water is urgently required as in a disaster or the like at an early stage. In consequence, even when the water is urgently required for the disaster district or the like regardless of the taste of the water, the switch SWT2 can be operated to feed the potable water with a minimum treatment.

It is to be noted that in a case where the water feed device S has the constitution of the present embodiment, in addition to the treatment modes described above in detail, there can selectively be constituted a treatment mode in which the for-treatment water from the water tank 11 is supplied through the inorganic substance removal treatment means 2 only, and bypasses the organic substance removal treatment means 3 and the mineral addition treatment means 7; a treatment mode in which the water is supplied through the mineral addition treatment means 7 only, and bypasses the inorganic substance removal treatment means 2 and the organic substance removal treatment means 3; and a mode in which the water bypasses any one of the treatment means, that is, the treatment functions of all the treatment means are not performed. Furthermore, the treatment mode in which the for-treatment water received in the storage tank 8 is supplied to the circulation circuit C is not limited to the treatment mode of the switch SWT5 described above. The device may include a treatment mode in which the for-treatment water from the circulation circuit C is successively supplied through the inorganic substance removal treatment means 2 and the organic substance removal treatment means 3; and a treatment mode in which the water is supplied through the inorganic substance removal treatment means 2 only. These treatment modes can selectively be constituted.

As described above in detail, the water feed device S of the present invention selects the treatment function to be performed with respect to the for-treatment water in accordance with a use situation or the type of the for-treatment water, and can perform an optimum treatment. In consequence, the versatility of the water feed device S can be improved.

It is to be noted that in the present embodiment, the inorganic substance removal treatment means 2 is constituted separately from the organic substance removal treatment means 3, the organic substance removal treatment means 3 is provided on the outlet side of the inorganic substance removal treatment means 2, and the for-treatment water successively flows through the inorganic substance removal treatment means 2 and the organic substance removal treatment means 3. In this constitution, the inorganic substance removal treatment means 2 and the organic substance removal treatment means 3 are constituted separately from each other, whereby the inorganic substances and the organic substances can separately removed from the for-treatment water. Moreover, the for-treatment water can be supplied through one of the means. In particular, the for-treatment water subjected to the inorganic substance removal treatment of the inorganic substance removal treatment means 2 is supplied through the inorganic substance removal treatment means 2. In consequence, a disadvantage that the treatment of the organic substances is adversely affected by the inorganic substances in the for-treatment water can be avoided.

In a case where the organic substance removal treatment means 3 is, for example, means for adsorptive removal the organic substances by use of a carbon fiber, the inorganic substances which might be attached to the electrodes made of the carbon fiber to disturb the adsorption are removed by the inorganic substance removal treatment means 2, and then such organic substances can be adsorbed and removed. Therefore, the adsorption removal (germ removal) treatment of the organic substances by the carbon fiber can effectively be performed, and the carbon fiber does not easily deteriorate. In consequence, the performance and the durability of the organic substance removal treatment means 3 can be improved.

However, the present invention, especially the invention of the fourth aspect is not limited to this example, and the inorganic substance removal treatment means 2 and the organic substance removal treatment means 3 may effectively be formed integrally. Specifically, when means for removing the inorganic substances by use of the carbon fiber (CF) or means for removing the inorganic substances by use of a reverse osmosis membrane is used as the inorganic substance removal treatment means 2, in addition to the inorganic substances, organic substances such as the germs can simultaneously be treated. Therefore, the inorganic substance removal treatment means 2 and the organic substance removal treatment means 3 can integrally be formed. That is, the treatment of the inorganic substances and the organic substances can be performed by one device, and hence the whole device can be miniaturized.

Furthermore, in the embodiment, the organic substance removal treatment means 3 is constituted of one of means for adsorptive removal the organic substances by use of the carbon fiber and means using a filter film. However, the organic substance removal treatment means may be constituted of both the means for adsorptive removal the organic substances by use of the carbon fiber and the means using the filter film, and one of the means may selectively be operated in accordance with each treatment mode or the like, or both of the means may simultaneously be operated. Moreover, in the inventions of the fourth to seventh aspects, the organic substance removal treatment means 3 is not limited to the means for adsorptive removal the organic substances by use of the carbon fiber or the means using the filter film. That is, the organic substance removal treatment means 3 according to the inventions of the fourth to seventh aspects may effectively have any constitution as long as the organic substances can be removed from the for-treatment water. For example, the means may generate hypochlorous acid, ozone or the like by electrolysis to sterilize the for-treatment water, or may sterilize the for-treatment water by ozone discharge. However, in this case, hypochlorous acid or ozone has to be generated in the for-treatment water. Even when the minute amount of hypochlorous acid or ozone is generated, the tasty components of the for-treatment water are influenced, and the flavor might be impaired or deteriorated. Similarly, the inorganic substance removal treatment means 2 according to the inventions of the fourth to seventh aspects may effectively have any constitution as long as the inorganic substances can be removed from the for-treatment water.

### Embodiment 2

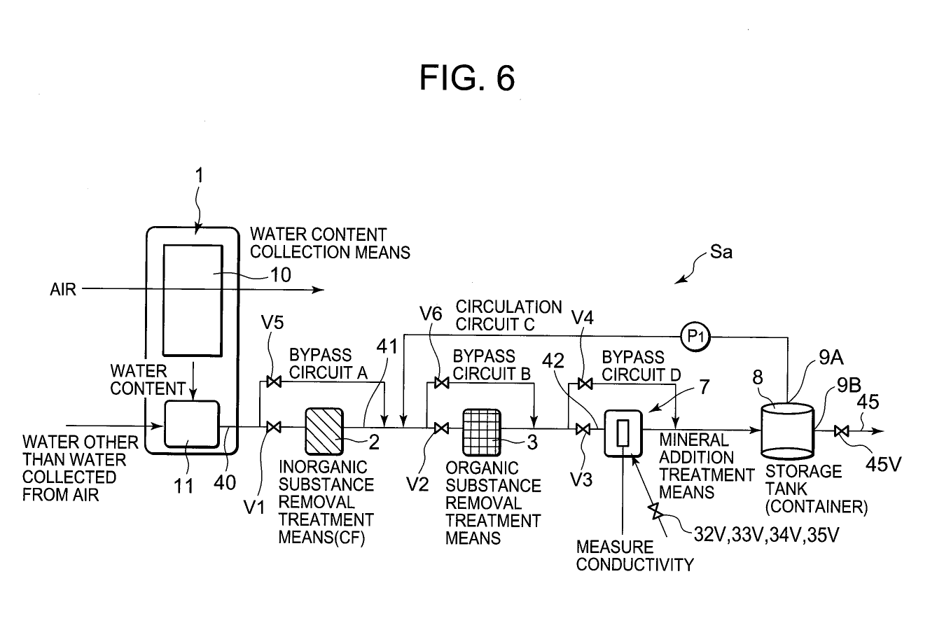

On the other hand, in Embodiment 1 described above, a storage tank 8 is interposed between organic substance removal treatment means 3 and mineral addition treatment means 7. In this case, in the storage tank 8, water having a state in which any mineral component has not been added by the mineral addition treatment means 7 is received. When a user selects switches SWM1 to SWM4, a predetermined amount of desired mineral water (any mineral component is not added in a case where the switch SWM4 is selected), for example, the water for each cup 115 can be fed, and water having different properties can be fed in accordance with user's selection. However, as shown in FIG. 6, the storage tank 8 may be provided in the subsequent stage of the mineral addition treatment means 7, and water to which mineral components have been added by the mineral addition treatment means 7 may be received in the storage tank 8.

In a water feed device Sa of the present embodiment shown in FIG. 6, a pipe 40 connected to the outlet of a water tank 11 is connected to the inlet side of inorganic substance removal treatment means 2, and a pipe 41 connected to the outlet side of the inorganic substance removal treatment means 2 is connected to the inlet side of the organic substance removal treatment means 3. Then, a pipe 42 connected to the outlet side of the organic substance removal treatment means 3 is connected to the inlet side of the mineral addition treatment means 7 (an inlet provided on one side of a water tank 30), and a pipe 43 connected to the outlet side of the mineral addition treatment means 7 (an outlet provided on the other side of the water tank 30) is connected to the inlet side (an inlet provided on the one side of the storage tank 8) of the storage tank 8. As described above, the for-treatment water successively flows through the inorganic substance removal treatment means 2, the organic substance removal treatment means 3 and the mineral addition treatment means 7, respectively.

That is, the storage tank 8 of the present embodiment is storage means for receiving for-treatment water obtained in a case where one of the inorganic substance removal treatment means 2, the organic substance removal treatment means 3 and the mineral addition treatment means 7 performs a treatment function or all the treatment means (the inorganic substance removal treatment means 2, the organic substance removal treatment means 3 and the mineral addition treatment means 7) perform the treatment function or in a case where all the treatment means (the inorganic substance removal treatment means 2, the organic substance removal treatment means 3 and the mineral addition treatment means 7) do not perform the treatment function. It is to be noted that in FIG. 6, components denoted with the same reference numerals as those of FIG. 1 produce the same or similar effects or functions, and hence the description thereof is omitted here.

Specifically, an inlet formed on one side of the storage tank 8 is connected to the pipe 43, and the pipe 43 feeds, into the storage tank 8, the for-treatment water obtained in a case where one of the inorganic substance removal treatment means 2, the organic substance removal treatment means 3 and the mineral addition treatment means 7 performs a treatment function, all the treatment means (the inorganic substance removal treatment means 2, the organic substance removal treatment means 3 and the mineral addition treatment means 7) perform the treatment functions or all the treatment means (the inorganic substance removal treatment means 2, the organic substance removal treatment means 3 and the mineral addition treatment means 7) do not perform the treatment functions. Moreover, the storage tank 8 is provided with two taking ports 9A, 9B on the other side, the taking port 9A is connected to a pipe 45 provided with an electromagnetic valve 45V, and the for-treatment water in the storage tank 8 can be taken as potable water from the pipe 45.

The water feed device Sa of the present embodiment having the above constitution is stored in a main body X shown in FIG. 2 in the same manner as in Embodiment 1, and water content collection means 1, the water tank 11, the inorganic substance removal treatment means 2, the organic substance removal treatment means 3, the mineral addition treatment means 7 and the storage tank 8 are successively arranged from the upside to the downside in the upper part of the dispenser X.

Then, the water selection switches SWM1 to SWM3 are provided on the front surface of an opening/closing door 128 of the dispenser X in the same manner as in the above embodiment. It is to be noted that in the present embodiment, the switch SWM4 is used as a potable water switch for discharging the water from the storage tank 8.

Furthermore, a plurality of (five in the present embodiment) treatment function selecting switches SWT1, SWT2, SWT3, SWT4 and SWT5 are installed right above the switches SWM1 to SWM4. The treatment function selecting switches SWT1, SWT2, SWT3, SWT4 and SWT5 are selection means for selecting whether or not the respective treatment means (the inorganic substance removal treatment means 2, the organic substance removal treatment means 3 and the mineral addition treatment means 7) perform the treatment functions with respect to the for-treatment water. The treatment function selecting switches SWT1 to SWT5 are connected to control means.

Moreover, a potable water taking port 50 for discharging the for-treatment water treated in the water feed device Sa and received in the storage tank 8 is formed under the main body X. When, for example, the potable water switch SWM4 is operated, the electromagnetic valve 45V of the pipe 45 is opened, and the potable water is fed to a cup 115 arranged on a table 114 in the potable water taking port 50 through the pipe 45 and a nozzle 113.

Next, an operation of the water feed device Sa of the present embodiment having the above constitution will be described. When the treatment mode is selected in accordance with the type of the for-treatment water to be used by a user, a use situation and the like, the control means controls the operations of the treatment means, electromagnetic valves and the like in accordance with the treatment mode.

(1) Treatment Mode in which the Water Collected from Air is Used as the for-Treatment Water:

First, an operation in a case where the treatment function selecting switch SWT1 is selected will be described.

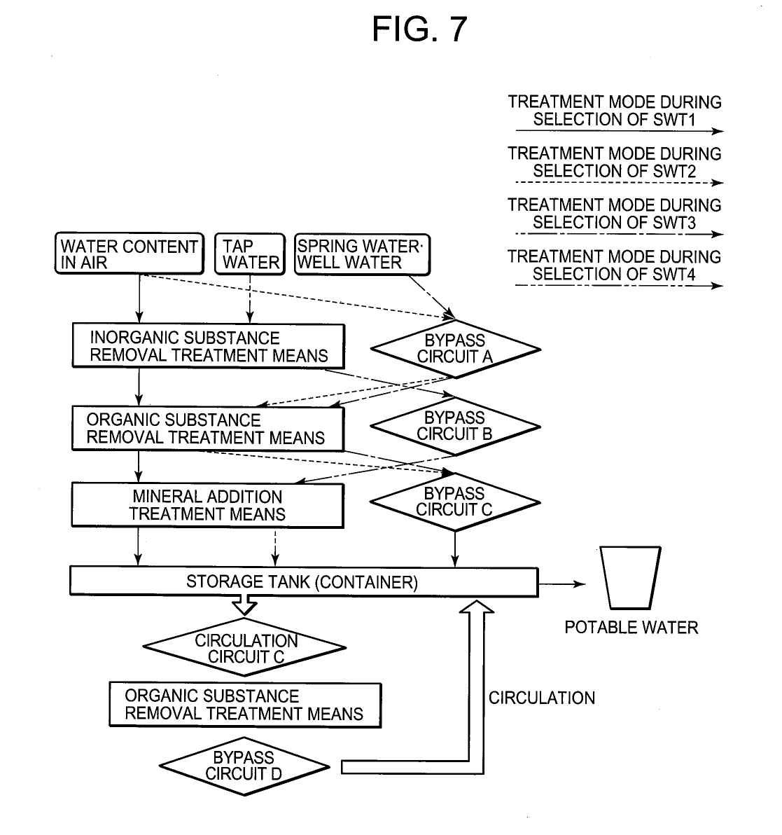

In this case, the water content collection means 1 collects the water content from the air, and this collected water content is used as the for-treatment water. When the treatment mode is selected (selected by the switch SWT1), the control means fully closes electromagnetic valves V5, V6 and V4 provided in bypass circuits A, B and D, and opens an electromagnetic valve V1 of the pipe 40, an electromagnetic valve V2 of the pipe 41 and an electromagnetic valve V3 of the pipe 42. In consequence, as shown by solid-line arrows in FIG. 7, the for-treatment water collected from the water content collection means 1 to the water tank 11 does not bypass any one of the inorganic substance removal treatment means 2, the organic substance removal treatment means 3 and mineral addition treatment means 7, and successively passes through the inorganic substance removal treatment means 2, the organic substance removal treatment means 3 and the mineral addition treatment means 7. Moreover, the control means starts the operations of the water content collection means 1, the inorganic substance removal treatment means 2, the organic substance removal treatment means 3 and the mineral addition treatment means 7.

In consequence, the air outside the water feed device S is blown to the collection means 1 by the blower, and the air is discharged from the device through a first air passage and a water content adsorption region of an adsorbent 10. At this time, the water content included in the air is adsorbed by the adsorbent 10 of a portion constituting the water content adsorption region, and the adsorbent is rotated by an electric motor to convey the water content to a water content discharge region. Then, blowing means is operated to discharge, to a condensing section, the air heated to a high temperature (e.g., +140° C.) by a heater through the water content discharge region of the adsorbent 10. In consequence, the air heated by the heater receives the water content adsorbed by the water content adsorption region of the adsorbent 10 in the water content discharge region of the adsorbent 10, and is then cooled and condensed in the condensing section. Then, the condensed water content is received in the water tank 11 positioned right under the condensing section. In consequence, the adsorbent 10 is rotated to continuously achieve the water content adsorption and discharge operations, so that the water can efficiently be collected from the air.

The water (the for-treatment water) once received in the water tank 11 successively passes through the inorganic substance removal treatment means 2 and the organic substance removal treatment means 3 positioned right under the water tank 11, and in this process, the above inorganic substances and organic substances such as germs are removed. Thus, the inorganic substance removal treatment means 2 removes dust included in the for-treatment water, the fine powder of zeolite and impurities such as cations (especially, the metal ions) or these scales, and the organic substance removal treatment means 3 removes the germs from the for-treatment water (germ removal), whereby the for-treatment water can be treated into the safe and potable water.

Furthermore, the for-treatment water subjected to the germ removal treatment by the organic substance removal treatment means 3 flows into the water tank 30 of the mineral addition treatment means 7. Here, the control means adds mineral components to the for-treatment water so as to obtain water having properties selected by the switches SWM1 to SWM3 provided on the front surface of the opening/closing door 128 of the main body X as described above. It is to be noted that in this case, an operation of the control means for adding the mineral components to the for-treatment water has been described above in Embodiment 1, and hence the description thereof is omitted.

Then, the for-treatment water to which the mineral components have been added by the mineral addition treatment means 7 is once received in the water tank 30. Subsequently, when a user operates the potable water switch SWM4, the electromagnetic valve 45V of the pipe 45 is opened for a predetermined short time, and the for-treatment water (the potable water) for one cup is fed to the cup 115 arranged on the table 114 in the potable water taking port 50.

### (2) Treatment Mode for Emergency

Next, a treatment mode for emergency in the present embodiment will be described. When the user selects the switch SWT2, a treatment for emergency is executed.

First, the control means fully closes the electromagnetic valve V1 of the pipe 40 and the electromagnetic valve V3 of the pipe 42, opens the electromagnetic valve V5 of the bypass circuit A and the electromagnetic valve V4 of the bypass circuit D, opens the electromagnetic valve V2 of the pipe 41, and fully closes the electromagnetic valve V6 of the bypass circuit B. In consequence, as shown by broken-line arrows in FIG. 7, the for-treatment water (in the present embodiment, the water content collected by the water content collection means 1 is used) collected from the water content collection means 1 to the water tank 11 bypasses the inorganic substance removal treatment means 2 to pass through the organic substance removal treatment means 3, and then bypasses the mineral addition treatment means 7. Moreover, the control means starts the operations of the water content collection means 1 and the organic substance removal treatment means 3.

Here, the water content collection means 1 performs a water content collecting operation in the same manner as described above, and hence the description thereof is omitted here. Then, the water (the for-treatment water) collected in the water tank 11 passes through the organic substance removal treatment means 3 via the bypass circuit A, and in this process, organic substances such as the germs are removed.

Then, the for-treatment water subjected to the germ removal treatment by the organic substance removal treatment means 3 is once received in the storage tank 8 via the bypass circuit D. In the same manner as described above, when the user operates the potable water switch SWM4, the electromagnetic valve 45V of the pipe 45 is opened for the predetermined short time, and the for-treatment water (the potable water) for one cup is fed to the cup 115 arranged on the table 114 in the potable water taking port 50.

(3) Treatment Mode in which Natural Water Such as Spring Water or Well Water is Used as the for-Treatment Water:

Next, a treatment mode in a case where natural water such as the spring water or the well water is used as the for-treatment water in the water feed device Sa of the present embodiment will be described. In a case where the user selects the switch SWT3, a treatment is executed so that the inorganic substance removal treatment means 2 and the mineral addition treatment means 7 are not operated with respect to the for-treatment water, and the only organic substance removal treatment means 3 is operated.

First, the control means fully closes the electromagnetic valve V1 of the pipe 40 and the electromagnetic valve V3 of the pipe 42, opens the electromagnetic valve V5 of the bypass circuit A and the electromagnetic valve V4 of the bypass circuit D, opens the electromagnetic valve V2 of the pipe 41, and fully closes the electromagnetic valve V6 of the bypass circuit B. In consequence, as shown by broken-line (one-dot broken-line) arrows in FIG. 7, the for-treatment water in the water tank 11 bypasses the inorganic substance removal treatment means 2 to pass through the organic substance removal treatment means 3, and then bypasses the mineral addition treatment means 7.

That is, the water (the for-treatment water) fed from the outside to the water tank 11 and once received in the water tank 11 passes through the organic substance removal treatment means 3 via the bypass circuit A, and in this process, organic substances such as the germs are removed. In this case, as described in the above embodiment in detail, the organic substance removal treatment means 3 is constituted of means for electrolyzing the organic substances by use of a carbon fiber or means using a filter film, whereby organic substances such as the germs can be removed without impairing any flavor of the for-treatment water.

Then, the for-treatment water subjected to the germ removal treatment of the organic substance removal treatment means 3 is once received in the storage tank 8 via the bypass circuit C. Then, in the same manner as described above, when the user operates the potable water switch SWM4, the electromagnetic valve 45V of the pipe 45 is opened for the predetermined short time, and the for-treatment water (the potable water) for one cup is fed to the cup 115 arranged on the table 114 in the potable water taking port 50.

Thus, when natural water such as the spring water or the well water is used as the for-treatment water in the treatment mode, the tasty components included in the for-treatment water are not impaired, the organic substances are removed while keeping the flavor of the spring water or the well water, and safe water can be manufactured.

(4) Treatment Mode in which Water Subjected to the Germ Removal Treatment, for Example, the Tap Water or the Like is Used as the for-Treatment Water:

Next, a treatment mode will be described in a case where water subjected to sterilization or the germ removal treatment, for example, the tap water or the like is used as the for-treatment water in the water feed device Sa of the present embodiment. In this case, the organic substances have already removed from the tap water, and hence the water does not have to be treated by the organic substance removal treatment means. That is, the inorganic substance removal treatment means once removes, from the tap water, all the inorganic substances including the cations (especially, the metal ions) which impair the flavor, and then the mineral addition treatment means merely adds mineral components such as magnesium, calcium, potassium, sodium and silica which are the tasty components of the water, whereby the tap water can be treated into the safe and good water. That is, when the user selects the switch SWT4, a treatment is executed corresponding to the water subjected to the organic substance removal treatment.

First, the control means opens the electromagnetic valve V1 of the pipe 40 and the electromagnetic valve V3 of the pipe 42, closes the electromagnetic valve V5 of the bypass circuit A and the electromagnetic valve V4 of the bypass circuit D, closes the electromagnetic valve V2 of the pipe 41, and opens the electromagnetic valve V6 of the bypass circuit B. In consequence, as shown by broken-line (two-dot broken-line) arrows in FIG. 7, the for-treatment water in the water tank 11 passes through the inorganic substance removal treatment means 2, then bypasses the organic substance removal treatment means 3, and passes through the mineral addition treatment means 7. Moreover, the control means starts the operations of the inorganic substance removal treatment means 2 and the mineral addition treatment means 7.

Then, the water (the for-treatment water) fed from the outside to the water tank 11 and once received in the water tank 11 passes through the inorganic substance removal treatment means 2, and in this process, the dust included in the for-treatment water, the fine powder of zeolite, and impurities (inorganic substances) such as the cations (especially, the metal ions) and these scales are removed. Furthermore, the for-treatment water subjected to the inorganic substance removal treatment of the inorganic substance removal treatment means 2 bypasses the organic substance removal treatment means 3, and flows into the water tank 30 of the mineral addition treatment means 7. Here, as described above, the control means adds the mineral components to the for-treatment water so as to obtain the water having the properties selected by the switches SWM1 to SWM3 provided on the front surface of the opening/closing door 128 of the main body X as described above. It is to be noted that in this case, the operation of the control means for adding the mineral components to the for-treatment water has been described above in Embodiment 1, and hence the description thereof is omitted.

Then, the for-treatment water to which the mineral components have been added by the mineral addition treatment means 7 is once received in the water tank 30. Subsequently, when the user operates the potable water switch SWM4, the electromagnetic valve 45V of the pipe 45 is opened for the predetermined short time, and the for-treatment water (the potable water) for one cup is fed to the cup 115 arranged on the table 114 in the potable water taking port 50.

Thus, when the water already subjected to the organic substance removal treatment, for example, the tap water or the like is used as the for-treatment water in the present treatment mode, the organic substance removal treatment means 3 is not operated, and the inorganic substance removal treatment means 2 once removes the inorganic substances from the for-treatment water. Afterward, the mineral addition treatment means 7 merely adds mineral components such as magnesium, calcium, potassium, sodium and silica which are the tasty components of the water, whereby the tap water can be treated into the safe and good water.

### (5) Treatment Mode During Storage

Next, a treatment mode during storage will be described. When the user selects the switch SWT5, the removal treatment of the organic substances from the for-treatment water received in the storage tank 8 is executed.

In the treatment mode, first, the control means fully closes the electromagnetic valve V1 of the pipe 40, the electromagnetic valve V5 of the bypass circuit A, the electromagnetic valve V6 of the bypass circuit B and the electromagnetic valve V3 of the pipe 42, and opens the electromagnetic valve V2 of the pipe 41 and the electromagnetic valve V4 of the bypass circuit D. Moreover, the operation of a pump P1 provided in a circulation circuit C is started. In consequence, as shown by outline arrows in FIG. 7, the for-treatment water pumped up from the storage tank 8 to the circulation circuit C by the pump P1 of the circulation circuit C and discharged to the pipe 41 on the inlet side of the organic substance removal treatment means 3 passes through the organic substance removal treatment means 3, then bypasses the mineral addition treatment means 7 and returns into the storage tank 8 again.

That is, when the control means starts the operation of the organic substance removal treatment means 3, the water (the for-treatment water) once received in the storage tank 8 is pumped up to the circulation circuit C by the operation of the pump P1. Then, the for-treatment water passes through the circulation circuit C, the pipe 41 and the organic substance removal treatment means 3, and in this process, organic substances such as the germs are removed. In consequence, the organic substances (the germs) generated in the for-treatment water can be removed to make the potable and safe water again.

Then, the for-treatment water subjected to the germ removal treatment of the organic substance removal treatment means 3 is received in the storage tank 8 again via the bypass circuit D.

Thus, in the present treatment mode, the for-treatment water in the storage tank 8 is supplied to the circulation circuit C, subjected to the germ removal treatment of the organic substance removal treatment means 3 and stored in the storage tank 8 for a long period. In consequence, organic substances such as the generated germs can be removed, and the water can be stored as the potable water again.

As described above, even in the water feed device Sa of the present embodiment, in the same manner as in the above embodiment, the treatment function to be performed with respect to the for-treatment water is selected in accordance with the user situation and the type of the for-treatment water, an optimum treatment can be performed and a similar effect can be obtained.

### Embodiment 3

It is to be noted that the water content collection means 1 of Embodiments 1, 2 described above collects a water content from air by use of a rotary dehumidifier including an adsorbent (a hygroscopic substance) 10 capable of adsorbing and discharging the water content, but the water content collection means 1 is not limited to the above constitution. The water content collection means may be constituted of, for example, an evaporator having a refrigeration cycle constituted of a compressor, a radiator, a pressure reduction unit and the evaporator. The air from the outside of the water content collection means 1 may be blown to the evaporator, and the water content in the air may be condensed and collected by a refrigerant heat absorbing function in such an evaporator.

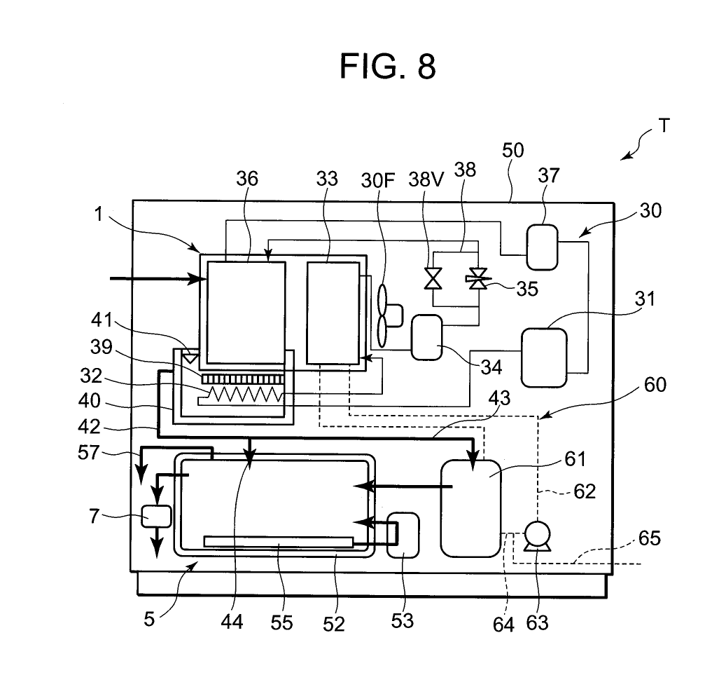

FIG. 8 is an inner constitution diagram of a water feed device T including the water content collection means 1 constituted of a so-called refrigeration cycle type dehumidifier including an evaporator 36 of a refrigeration cycle 30. It is to be noted that in FIG. 8, components denoted with the same reference numerals as those of FIGS. 1 to 7 have similar functions and effects, and the description thereof is omitted. The water feed device T of the present embodiment is stored in a substantially rectangular parallelepiped box body 50 having an air (outside air) outflow/inflow port (not shown) capable of sucking the outside air, supplying the air through the evaporator 36 of a heat exchanger described later and then discharging the air to the outside.

The refrigeration cycle 30 includes a compressor 31, the above-mentioned heat exchanger, an expansion valve 35 and the like. The heat exchanger of the present embodiment is constituted of a radiator (a condenser) 33 for releasing heat from a refrigerant, and the evaporator 36 for absorbing the heat of the refrigerant. Specifically, a pipe extending from the compressor 31 passes through a storage tank 40, and is connected to the inlet of the radiator 33. The radiator 33 is a heat exchanger capable of switching air cooling and water cooling in accordance with an operating situation or the like. Specifically, to switch the air cooling and the water cooling, the radiator 33 may be switched to the water cooling for use on conditions that a large amount of water can be collected by the water content collection means 1 in the initial stage of an operation. The radiator 33 is provided with a cooling water circulation path 60 described later through which cooling water flows and which is arranged so that heat exchange between the path and the refrigerant flowing through the radiator 33 can be performed.

The cooling water circulation path 60 supplies the cooling water through the radiator 33 to water-cool the refrigerant flowing through the radiator 33, and is constituted of a cooling water tank 61 and a circulation pump 63. That is, a pipe 62 connected to the outlet of the cooling water tank 61 is arranged so that heat exchange between the pipe and the radiator 33 can be performed, and is then connected to the inlet of the circulation pump 63, and a pipe 64 connected to the outlet of the circulation pump 63 is connected to the inlet of the cooling water tank 61 to constitute an annular cycle.

Then, when the circulation pump 63 is operated, the cooling water in the cooling water tank 61 passes through the pipe 62 and is sucked by the circulation pump 63. Then, the cooling water sucked by the circulation pump 63 is discharged to the pipe 64 to return into the cooling water tank 61, thereby repeating this cycle.

The cooling water tank 61 is configured to receive a water content which is condensed on the surface of the evaporator 36 as described later and which drops down to a drain pan 39 to flow into the storage tank 40. Moreover, the middle portion of the pipe 64 is connected to a pipe 65 for discharging, from the cooling water circulation path 60, the cooling water circulated through the path or feeding the water into the cooling water circulation path 60. Furthermore, the cooling water tank 61 is constituted so that the cooling water received in the tank 61 can be fed to a storage tank 52 as described later.

On the other hand, the radiator 33 on an outlet side is connected to the expansion valve 35 via a receiver (or a receiver tank) 34. The expansion valve 35 is a pressure reduction unit for reducing the pressure of the refrigerant from which the heat has been released by the radiator 33, and a pipe exiting from the expansion valve 35 is connected to the inlet of the evaporator 36 of the heat exchanger. The heat exchanger of the present embodiment is constituted of the radiator 33 and the evaporator 36 as described above, and a blower 30F is provided as blowing means in the vicinity of the heat exchanger. As shown in bold-line arrows in FIG. 8, the blower 30F is arranged so that the air from the outside of the container 50 is successively supplied through the evaporator 36 and the radiator 33 and can then be discharged from the container 50.

Then, a pipe exiting from the evaporator 36 is connected to the inlet side of the compressor 31 via a receiver (a receiver tank) 37 to constitute the annular refrigeration cycle 30. Furthermore, the refrigeration cycle 30 is provided with a hot gas pipe 38 provided so as to bypass the expansion valve 35 and an electromagnetic valve 38V which controls the inflow of the refrigerant to the pipe 38. This hot gas pipe 38 is provided so as to execute a defrosting operation so that when frost is attached to the evaporator 36, the high-temperature refrigerant is supplied through the evaporator 36 to melt the frost.

The evaporator 36 constitutes the water content collection means 1 of the present invention. The water content collection means 1 of this embodiment includes the evaporator 36, and the drain pan 39 and the storage tank 40 provided right under the evaporator 36. The drain pan 39 is a receiving pan for receiving water droplets which are attached to the surface of the evaporator 36 and which finally drop down as the water droplets. The drain pan 39 is provided with small holes extending through the pan in a vertical direction, and the water droplets (including the frost attached to the evaporator 36 and melted into the water) which have dropped from the evaporator 36 onto the drain pan 39 flow into the storage tank 40 through these small holes.

The storage tank 40 is a tank for temporarily receiving, from the drain pan 39, the water content collected from the air by the evaporator 36, and this storage tank 40 is provided with a float switch 41 which detects the water level of the water received in the storage tank 40 to notify that the water has reached a predetermined water level.

Moreover, under the drain pan 39 in the storage tank 40, a pipe is arranged which is connected to the outlet side of the compressor 31 of the refrigeration cycle 30 to extend to the inlet of the radiator 33. The pipe is constituted so that the water accumulated in the storage tank 40 can be heated. Thus, the pipe connected to the outlet side of the compressor 31 is provided in the storage tank 40, whereby the high-temperature refrigerant compressed by the compressor 31 can be supplied through the storage tank 40 to heat the water accumulated in the tank 40. In consequence, the water in the storage tank 40 can be heated and sterilized using the heat of the hottest refrigerant discharged from the compressor 31.

Then, the storage tank 40 is connected to one end of a pipe 42 for discharging the water accumulated in the storage tank 40. This pipe 42 is branched into two pipes, one branched pipe 43 is connected to the cooling water tank 61, and the other pipe 44 is connected to the storage tank 52 of removal means 5, so that it can selectively be switched whether to supply the water of the storage tank 40 to the cooling water tank 61 or the storage tank 52. The water fed from the storage tank 40 to the storage tank 52 is used as for-treatment water, and water fed from the storage tank 40 to the cooling water tank 61 is used as the cooling water of the radiator 33.

The removal means 5 includes a CF electrolysis treatment unit (a CF module) 53 capable of simultaneously removing inorganic substances and organic substances contained in the for-treatment water. That is, the removal means 5 of the present embodiment includes inorganic substance removal treatment means constituted integrally with organic substance removal treatment means, and is constituted of the storage tank 52, the CF electrolysis treatment unit 53 and a pipe 55 which connects the storage tank 52 to the CF electrolysis treatment unit 53. The CF electrolysis treatment unit 53 is a unit including electrodes made of a carbon fiber in a water tank described in the above embodiments in detail. When potentials are applied to the electrodes, the inorganic substances, germs (the organic substances) and the like in the for-treatment water are positively adsorbed by the electrodes.

Furthermore, the storage tank 52 of the removal means 5 is provided with a taking port (not shown) for discharging the for-treatment water received in the storage tank 52, and a pipe having one end thereof connected to this taking port opens in mineral addition treatment means 7. It is to be noted that the mineral addition treatment means 7 is similar to that of the above embodiments, and hence the detailed description thereof is omitted in the present embodiment.

Next, an operation of the water feed device T according to the present embodiment having the above constitution will be described. It is to be noted that during a usual operation, the electromagnetic valve 38V of the hot gas pipe 38 is fully closed. When the operation of the water feed device T is started, the compressor 31 and the blower 30F of the refrigeration cycle 30 are started. In consequence, the refrigerant is compressed by the compressor 30 to form a high-temperature high-pressure refrigerant gas, and the gas is discharged from the compressor 30, passes through the storage tank 40, and then flows into the radiator 33. In the radiator 33, the refrigerant performs heat exchange between the refrigerant and cool air and/or the cooling water supplied through the evaporator 36 to release the heat, and then reaches the expansion valve 35 through the receiver 34. Then, the refrigerant having the pressure reduced by the expansion valve 35 flows in the evaporator 36, and absorbs the heat from the outside air blown by the blower 30F to evaporate.

Afterward, the refrigerant discharged from the evaporator 36 is sucked by the compressor 31 via the receiver 37, and this cycle is repeated. On the other hand, the air sucked into the box body 50 by the blower 30F performs heat exchange between the air and the refrigerant in the evaporator 36, and is cooled. In consequence, the water content included in the air is condensed, and attached as the water droplets or the frost to the surface of the evaporator 36. That is, when the air includes a large amount of water content or the refrigerant in the evaporator 36 has a low heat absorption ability, the water content cooled in the evaporator 36 is easily attached to the evaporator 36. The water content attached as the water droplets to the surface of the evaporator 36 finally grows, drops down onto the drain pan 39 owing to gravity, and is then received in the storage tank 40.

On the other hand, when the air includes a small amount of water content or the refrigerant in the evaporator 36 has a high heat absorption ability, the water content easily grows as the frost attached to the evaporator 36. When the frost grows in the evaporator 36 in this manner, the defrosting operation is performed. During the defrosting operation, the operation of the blower 30F is stopped, and the electromagnetic valve 38V of the hot gas pipe 38 is opened. In consequence, the refrigerant compressed by the compressor 31 flows into the evaporator 36 in a high-temperature high-pressure state as it is. In consequence, the frost attached to the evaporator 36 gradually melts, drops down as the water droplets on the drain pan 39 and is then received in the storage tank 40.

Then, when the frost attached to the evaporator 36 is completely removed, the operation of the blower 30F is resumed, and the electromagnetic valve 38V is fully closed, thereby returning to the usual operation.

When the above operation is continuously executed, the water content is gradually stored in the storage tank 40. However, this storage tank 40 is provided with the pipe connected to the outlet side of the compressor 31 and extending to the inlet of the radiator 33 as described above. Therefore, the water stored in the tank 40 is heated and sterilized by the heat of the refrigerant passing through the pipe.

On the other hand, when the predetermined amount of water is accumulated in the storage tank 40 (such a water amount is detected by the float switch 41), the water in the storage tank 40 is discharged to the cooling water tank 61 or the storage tank 52 of the removal means 5. Then, the water supplied into the cooling water tank 61 is used as the cooling water of the radiator 33. The water (the for-treatment water) which has flowed into the storage tank 52 passes through the pipe 55 to enter the CF electrolysis treatment unit 53, where the inorganic substances and the organic substances are removed as described in the above embodiments in detail. Afterward, the water returns into the storage tank 52, and received in the storage tank 52.

Then, the for-treatment water received in the storage tank 52 is discharged from the taking port of the storage tank 52, if necessary, and the mineral addition treatment means 7 adds the mineral components to the water as in the above embodiment to adjust the water into good water.

When the water feed device T of the present embodiment is used in this manner, in the same manner as in the above embodiment, the water content is collected from the air, and the inorganic substances and the organic substances can be removed from the water by the removal means 5 to make potable water.

In particular, the water feed device T of the present embodiment is large-sized, and can treat a large amount of water as compared with the water feed devices of the above embodiments. Moreover, when the water feed device T is operated using a nighttime electric power, use cost can be decreased.

Moreover, in a case where the water is accumulated above a predetermined full water level in the storage tank 52, when an overflow port 57 capable of discharging the water from the device is formed, the electrolysis treatment unit 53 can continuously be operated to constantly continue masking the water. Then, the water overflowing from the storage tank 52 can be discharged from the overflow port 57. In consequence, fresh water can constantly be stored in the storage tank 52.

It is to be noted that the removal means 5 of the present embodiment uses the CF electrolysis treatment unit 53, and removes the inorganic substances and the organic substances contained in the for-treatment water by the CF electrolysis treatment unit 53, but this is not restrictive, and the inorganic substances and the organic substances may be removed in the storage tank 52.

Furthermore, when, for example, an electrolysis deposition module is attached to the drain pan 39 positioned under the evaporator 36 to receive the water droplets from the surface of the evaporator 36 in the above embodiment, it is possible to prevent, in advance, an disadvantage such as the propagation of the germs or the deposition of scales in the drain pan 39.

### Embodiment 4

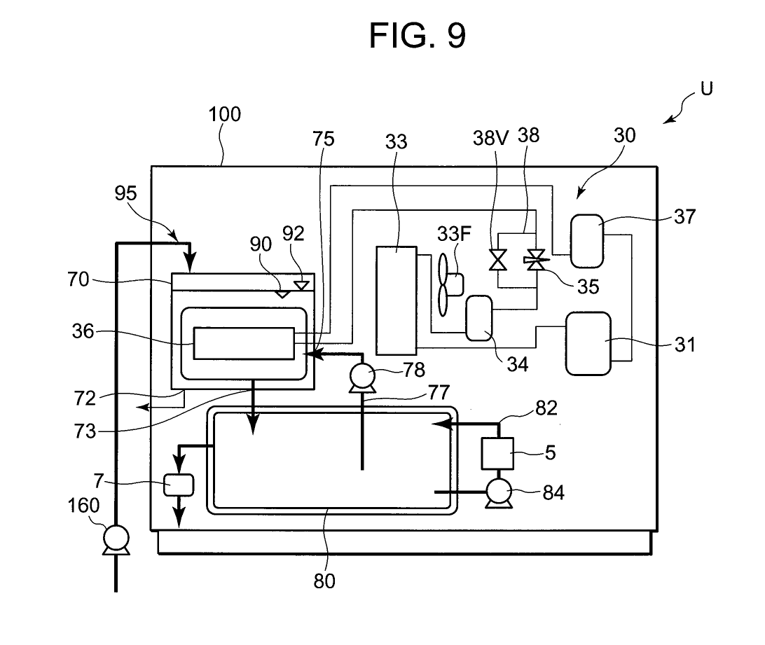

Next, a water feed device U according to still another embodiment of the present invention will be described with reference to FIG. 9. FIG. 9 is an inner constitution diagram of the water feed device U according to this embodiment. It is to be noted that in the present embodiment, components denoted with the same reference numerals as those of the above embodiments have similar functions and effects, and hence the description thereof is omitted. The water feed device U of the present embodiment is a device which pumps up water (underground water) as for-treatment water from underground by a pump 160, to treat the underground water.

The water feed device U is stored in a substantially rectangular parallelepiped box body 100 having an opening for introducing the underground water, and is constituted of ice generation means 95, treatment means 5 and mineral addition treatment means 7. The ice generation means 95 freezes water, and then melts the generated ice. In the present embodiment, the water obtained by freezing the underground water and melting the generated ice in the ice generation means 95 is treated as the for-treatment water by the treatment means 5 (inorganic substance removal treatment means and organic substance removal treatment means) of the subsequent stage.

That is, the ice generation means 95 is provided so as to remove, to a certain degree, impurities such as dust and scales included in the underground water before the underground water is treated by the treatment means 5. This water is treated as the for-treatment water by the treatment means 5, whereby a smooth removal treatment can be performed in the treatment means 5.

The ice generation means 95 is constituted of a water tank 70 which receives water (the underground water pumped up from underground), an evaporator 36 of a refrigeration cycle 30 immersed into the water received in this water tank 70 and the like. The refrigeration cycle 30 is similar to that of the above second embodiment, and hence in the present embodiment, an only constitution different from that of the above third embodiment will be described. The description of a similar constitution is omitted.

That is, in the above second embodiment, the radiator 33 is a heat exchanger configured to switch the water cooling and the air cooling, and during such air cooling, the refrigerant is cooled by the air cooled in the evaporator 36. However, the radiator 33 of the present embodiment is an air cooling system heat exchanger. When a blower 33F is operated, air is directly blown to the radiator 33 from the outside of the box body 100, passes through the radiator 33, and is then discharged from the box body 100. Moreover, the evaporator 36 is a water cooling system heat exchanger which is provided in the water tank 70 and which absorbs heat from the water received in the water tank 70. Furthermore, a pipe connected to the outlet side of a compressor 31 in the present embodiment is connected to the inlet of the radiator 33.

The lower part of the water tank 70 is provided with a water discharge port 72 for discharging the water from the water tank 70 and a taking port 73 for supplying the for-treatment water to a storage tank 80 described later. The water discharge port 72 and the taking port 73 are openably closed by valves (not shown), respectively. Furthermore, the water tank 70 is provided with an intake port 75 for returning, to the water tank 70, the for-treatment water received in the storage tank 80. A pipe 77 immersed in the for-treatment water of the storage tank 80 is inserted into and connected to one end of the intake port 75, and the other end of the pipe 77 opens in the water tank 70. Moreover, the middle portion of the pipe 77 is provided with a re-refining pump 78 for pumping up the for-treatment water from the storage tank 80 to return the water into the water tank 70.

Moreover, the water tank 70 includes a water feed detection switch 90 which detects the water level of the water received in the water tank 70 and which stops the operations of the pumps 160, 78 to stop the water feed into the water tank 70 in a case where a predetermined amount of for-treatment water is received in the water tank 70. The water tank also includes a water level detection switch 92 for detecting that the for-treatment water in the water tank 70 has been frozen. The water level detection switch 92 of the present embodiment is a contact system switch installed slightly above the water feed detection switch 90 in the water tank 70. The water surface in the water tank 70 does not come in contact with the water level detection switch 92 (an OFF-state), before the water feed detection switch 90 detects that the predetermined amount of for-treatment water is received in the water tank 70 and the for-treatment water received in the water tank 70 freezes.

Then, when the water in the water tank 70 freezes, the surface of the ice comes in contact with the water level detection switch 92 to turn on the switch. That is, the water level detection switch 92 is configured to turn ON/OFF in accordance with a volume change accompanying a water state change.

It is to be noted that as described later in detail in the description of an operation, when the water level detection switch 92 is turned on, a defrosting operation of the refrigeration cycle 30 is executed, and the valve of the water discharge port 72 is opened.

On the other hand, the storage tank 80 is a tank for receiving the water (the for-treatment water) refined by the ice generation means 95 at least once, the storage tank 80 is connected to the pipe 77, and one end of the pipe opens in the for-treatment water received in the storage tank 80. Moreover, the storage tank 80 is connected to a pipe 82, and the pipe 82 is provided with a pump 84 for supplying the for-treatment water from the storage tank 80 to the treatment means 5. It is to be noted that as a constitution of the treatment means 5, the CF electrolysis treatment unit of the above second embodiment is used, and the description thereof is omitted here.

The operation of the water feed device U according to the present embodiment having the above constitution will be described. It is to be noted that during a usual operation, an electromagnetic valve 38V of a hot gas pipe 38 is fully closed in the same manner as in the above embodiments. Moreover, at the start of the operation, the valves of the water discharge port 72 and the taking port 73 are both closed. When the operation of the water feed device U is started, first the pump 160 is operated to pump up the water (the underground water), thereby feeding the water into the water tank 70. Then, when the water feed detection switch 90 detects a predetermined full water level, the operation of the pump 160 is stopped to stop the water feed to the water tank 70.

Next, the compressor 31 and the blower 33F of the refrigeration cycle 30 start. In consequence, the refrigerant is compressed by the refrigeration cycle 30 to form a high-temperature high-pressure refrigerant gas, is discharged from the refrigeration cycle 30, and flows into the radiator 33. In the radiator 33, the refrigerant performs heat exchange with the refrigerant and air blown by the blower 33F to release heat, and then reaches an expansion valve 35 through a receiver 34. The refrigerant having the pressure thereof reduced by the expansion valve 35 flows into the evaporator 36. Then, the refrigerant which has flowed into the evaporator 36 absorbs the heat from the water in the water tank 70, to evaporate.

Afterward, the refrigerant discharged from the evaporator 36 is sucked by the compressor 31 through a receiver 37, and this cycle is repeated. When such a cycle is repeated, the water in the water tank 70 is cooled, and gradually freezes at a freezing temperature (about ±0° C.). At this time, the water in the water tank 70 slowly freezes so that the freezing gradually spreads around the evaporator 36. At this time, the side surface of the water tank 70 in a position most distant from the evaporator 36, that is, the surface of the ice finally freezes. When the water is slowly frozen in this manner, the concentration of impurities around the center of the ice becomes lowest. The concentration of the impurities increases around the ice, and the concentration of the impurities on the surface of the ice becomes highest.

On the other hand, when the water in the water tank 70 freezes, the surface of the ice comes in contact with the water level detection switch 92 (ON). In consequence, a defrosting operation of the evaporator 36 is started. During the defrosting operation, the operation of the blower 33F is stopped, and the electromagnetic valve 38V of the hot gas pipe 38 is opened. Furthermore, the valve of the water discharge port 72 provided in the lower part of the water tank 70 is opened.

In consequence, the refrigerant compressed by the compressor 31 flows into the evaporator 36 in a high-temperature high-pressure state as it is. Owing to such a high-temperature refrigerant, the ice in the water tank 70 gradually starts melting from the surface thereof, and is discharged from the water discharge port 72. At this time, the water which starts melting is water including a large amount of impurities dissolved therein and having the frozen surface with the highest impurity concentration. Therefore, when this water is discharged from the water discharge port 72, the water impurity concentration can be decreased.

Then, with the elapse of, for example, a beforehand set predetermined time from a time when the defrosting operation starts, the valve of the water discharge port 72 is closed to stop the discharging of the water from the water discharge port 72. The valve of the taking port 73 is simultaneously opened. In consequence, the molten water is received in the storage tank 80. Thus, the water having the highest impurity concentration on the surface of the ice is discharged from the water discharge port 72, the water having the lowered impurity concentration can be received in the storage tank 80.

Afterward, when the defrosting operation ends, the valve of the taking port 73 is closed, the pump 160 is operated to feed the underground water to the water tank 70, and the above operation is repeated.

On the other hand, when the operation of the pump 84 is started, the water (the for-treatment water) received in the storage tank 80 is sucked from the pipe 82 to the pump 84, and discharged into the treatment means 5. Then, in the treatment means 5, as described in the above embodiments in detail, inorganic substances and organic substances are removed. Then, the for-treatment water received in the storage tank 80 is taken from the taking port of the storage tank 80, if necessary, and the mineral addition treatment means 7 adds mineral components to adjust the water into good water.

On the other hand, when the for-treatment water is treated by the ice generation means 95 but the for-treatment water received in the storage tank 80 still has a high impurity concentration, the for-treatment water in the storage tank 80 is again returned to the ice generation means 95, and the ice is generated again, and then melted to discharge the water having the high impurity concentration from the water discharge port 72. In this case, the impurity concentration of the for-treatment water received in the storage tank 80 can further be lowered, and the treatment means 5 can perform a smoother removal treatment.

On the other hand, in the water feed device according to the above embodiments, the for-treatment water from which the inorganic substances and the organic substances have been removed is used for a beverage application, but this is not restrictive, and the water feed device of the present invention may treat waste water.

1-16. (canceled)

17. A water feed device comprising:
water content collection means for collecting a water content included in air;
inorganic substance removal treatment means in which water collected by the water content collection means is for-treatment water and which removes inorganic substances contained in the for-treatment water; and
organic substance removal treatment means for removing organic substances contained in the for-treatment water.

18. The water feed device according to claim 17, wherein the water content collection means is an evaporator of a refrigeration cycle constituted by connecting a compressor, a radiator, a pressure reduction unit and the evaporator to one another via pipes, or an adsorbent configured to adsorb and discharge the water content.

19. The water feed device according to claim 17 or 18, further comprising: ice generation means for freezing the water, the water obtained by melting ice generated by the ice generation means being the for treatment water.

20. The water feed device according to any one of claims 17 to 19, further comprising:
mineral addition treatment means which is provided in the subsequent stage of the inorganic substance removal treatment means and the organic substance removal treatment means and which has one or more mineral components and which adds the mineral components to the for-treatment water; and
control means which has data concerning the one or more mineral components of mineral water and which controls the addition of the mineral components by the mineral addition treatment means in accordance with the selected mineral water.

21. The water feed device according to claim 20, wherein the control means allows the mineral addition treatment means to add solutions including the mineral components in such a predetermined order and/or from such a portion as to avoid the generation of precipitation accompanying the addition of the solutions including the mineral components.

22. The water feed device according to claim 20 or 21, wherein the control means controls the addition of the mineral components by the mineral addition treatment means based on the conductivity of the for treatment water.

23. The water feed device according to any one of claims 20 to 22, wherein the control means includes selection means for selecting whether or not, the inorganic substance removal treatment means, the organic substance removal treatment means or the mineral addition treatment means performs a treatment function with respect to the for-treatment water.

24. The water feed device according to claim 23, wherein it is constituted that the for-treatment water successively flows through the inorganic substance removal treatment means, the organic substance removal treatment means and the mineral addition treatment means, and
the selection means includes a bypass circuit which bypasses the treatment means, respectively, to supply the for-treatment water, and flow path control means for controlling whether to supply the for-treatment water to the treatment means or the bypass circuit.

25. The water feed device according to any one of claims 20 to 24, wherein the inorganic substance removal treatment means is constituted of means for removing cations and/or scale components contained in the for-treatment water, and
the organic substance removal treatment means is constituted of means for sterilizing the for-treatment water or removing germs from the for-treatment water.

26. The water feed device according to claim 25, wherein the inorganic substance removal treatment means is constituted of one or all of means for electrolyzing the inorganic substances by use of a first carbon fiber, means for removing the inorganic substances by use of an adsorbent and means for removing the inorganic substances by use of a reverse osmosis membrane, and
the organic substance removal treatment means is constituted of one or both of means for adsorbing and removing the organic substances by use of a second carbon fiber and means for removing the organic substances by use of a filter film.

27. The water feed device according to claim 26, having a treatment mode to selectively operate the organic substance removal treatment means including one of the means for adsorbing and removing the organic substances by use of the second carbon fiber and the means for removing the organic substances by use of the filter film in a state in which the inorganic substance removal treatment means and the mineral addition treatment means are not operated with respect to the for-treatment water.

28. The water feed device according to any one of claims 20 to 27, having a treatment mode to operate the inorganic substance removal treatment means and the mineral addition treatment means in a state in which the organic substance removal treatment means is not operated with respect to the for-treatment water.

29. The water feed device according to any one of claims 20 to 28, further comprising: storage means for receiving the for-treatment water obtained in a case where one or all of the treatment means performs a treatment function or all the treatment means do not perform the treatment function; and a circulation circuit which circulates the for-treatment water received in the storage means between the storage means and the organic substance removal treatment means.

30. The water feed device according to claim 29, wherein the storage means is interposed between the inorganic substance removal treatment means as well as the organic substance removal treatment means and the mineral addition treatment means.

31. The water feed device according to claim 13 or 14, having a treatment mode to supply the for treatment water to the circulation circuit and to selectively operate the organic substance removal treatment means including one of the means for adsorptive removal the organic substances by use of the second carbon fiber and the means for removing the organic substances by use of the filter film.
